(19) United States
(12) Patent Application Publication
(10) Pub. No.: US 2024/0022897 A1
(43) Pub. Date: Jan. 18, 2024

(54) MANAGING DIFFERENT TYPES OF COMMUNICATION DEVICES

(71) Applicant: GOOGLE LLC, Mountain View, CA (US)

(72) Inventor: Chih-Hsiang Wu, Taoyuan City (TW)

(21) Appl. No.: 18/030,062

(22) PCT Filed: Sep. 16, 2021
(86) PCT No.: PCT/US21/50571

§ 371 Date: Apr. 3, 2023

Related U.S. Application Data
(60) Provisional application No. 63/198,189, filed on Oct. 1, 2020.

(51) Int. Cl. H04W 8/24

(52) U.S. Cl. CPC H04W 8/24; H04W 92/12

(57) ABSTRACT

A method in a base station for determining a capability of a user equipment (UE) includes receiving (1502) a payload transmission during a random access procedure with the UE. The method also includes determining (1504), using a logical channel identity included in the payload transmission, whether the UE is a reduced-capability device or a normal-capability device.

### FIELD OF THE DISCLOSURE

This disclosure relates to wireless communications and, more particularly, to managing different types of user equipment (UEs), such as UEs with normal capability and UEs with reduced capability.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as Multi-Radio Dual Connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, i.e., single connectivity (SC). The UE in SC only communicates with the MN (via the MCG). One base station and/or the UE determines that the UE should establish a radio connection with another base station. For example, one base station can determine to hand the UE over to the second base station, and initiate a handover procedure. The UE in other scenarios can concurrently utilize resources of a RAN node (e.g., a single base station or a component of a distributed base station or a disaggregated base station), interconnected by a backhaul.

UEs can use several types of SRBs and DRBs. So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MCG but using the lower-layer resources of the MN, the SN, or both the MN and the SN can be referred to as split DRBs.

UEs can perform handover procedures to switch from one cell to another, whether in single connectivity (SC) or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform PSCell change from a PSCell of a serving SN to a target PSCell of a target SN, or from a PSCell of a source DU of a base station to a PSCell of a target DU of the same base station, depending on the scenario.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2).

However, 3GPP has also proposed that normal-capability UEs (i.e., UEs conforming to Release 15 and/or 16) may co-exist with reduced-capability UEs. Compared to normal-capability UEs, reduced-capability UEs, also referred to as RedCap UEs or NR-light UEs, may have a lower bandwidth capability, a reduced processing capability, and/or fewer antennas. RedCap UEs also may lack support for dual connectivity and/or carrier aggregation.

If a base station is unaware of whether a UE is a reduced-capability UE or a normal-capability UE, the base station may attempt to communicate with a reduced-capability UE in a manner that the UE does not support. Alternatively, the base station that incorrectly assumes a particular UE is a reduced-capability UE may unnecessarily refrain from using NR techniques and features when communicating with a normal-capability UE, resulting in inefficiencies.

### SUMMARY

A base station of this disclosure identifies a capability type of a UE during connection establishment. While performing a random access procedure with the UE, the base station receives a random access preamble and a payload transmission. Using the random access preamble and/or the payload transmission, the base station can determine whether the UE is a reduced-capability device or a normal-capability device.

For example, the payload transmission can be a transmission on a physical uplink shared channel (PUSCH) (e.g., Msg3 during a four-step random access procedure or a payload of a MsgA during a two-step random access procedure). The base station can determine that the UE is a reduced-capability device based on a type of message, an information element, a temporary identifier, or a logical channel identity included in the PUSCH transmission.

In other examples, the base station can determine that the UE is a reduced capability device based on the random access preamble (e.g., based on time or frequency resources indicated by the preamble) used by the UE during the random access procedure.

After the base station determines the capability type of the UE, the base station can generate configuration parameters, such as a downlink control information (DCI), that are suitable for the UE.

One example embodiment of these techniques is a method implemented in a base station for determining a capability of a UE. The method can be executed by processing hardware and includes performing a random access procedure with the UE, including receiving a random access preamble and a payload transmission. The method also includes determining whether the UE is a reduced-capability device or a normal-capability device by analyzing at least one of the random access preamble or the payload transmission.

Another example embodiment of these techniques is a base station including processing hardware and configured to implement the method above.

A further example embodiment of these techniques is a method implemented in a UE for indicating a capability to a base station. The method can be executed by processing hardware and includes performing a random access procedure with the base station, including transmitting a random access preamble and a payload. The method also includes indicating whether the UE is a reduced-capability device or a normal-capability device through at least one of the random access preamble or the payload.

Yet another example embodiment of these techniques is a UE including processing hardware and configured to implement the method above.

### BRIEF DESCRIPTION OF THE DRAWINGS

FIG. 1A is a block diagram of an example system in which a RAN implements the techniques of this disclosure for identifying different types of UEs;

FIG. 1B is a block diagram of an example base station in which a central unit (CU) and a distributed unit (DU) can operate in the system of FIG. 1A;

FIG. 2 is a block diagram of an example protocol stack according to which the UE of FIG. 1A can communicate with base stations of FIG. 1A;

FIG. 3A is a messaging diagram of an example scenario in which a base station receives an RRC request from a UE and determines a type of the UE based on the type of RRC request;

FIG. 3B is a messaging diagram of an example scenario in which a base station receives an RRC request from a UE and determines a type of the UE based on a cause included in the RRC request;

FIG. 3C is a messaging diagram of an example scenario in which a base station receives an RRC request from a UE and determines a type of the UE based on whether a spare bit is flagged in the RRC request;

FIG. 3D is a messaging diagram of an example scenario in which a base station receives a MAC PDU including an RRC request and a logical channel identity (LCID) and determines a type of the UE based on the LCID;

FIG. 4 is a messaging diagram of an example scenario in which a base station receives an RRC request from a UE and determines a type of the UE based on the I-RNTI;

FIG. 5 is a messaging diagram of an example scenario in which a DU forwards an RRC request from a UE to a CU, and the CU determines a type of the UE based on the RRC request;

FIG. 6 is a messaging diagram of an example scenario in which a DU receives a MAC PDU including an RRC request and an LCID and determines a type of the UE based on the LCID;

FIG. 7 is a messaging diagram of an example scenario in which a UE transmits a random access (RA) preamble to a DU and the DU determines a type of the UE based on the RA preamble;

FIG. 8 is a messaging diagram of an example scenario in which a source base station (S-BS) transmits an indication of whether a UE is a first type or a second type to a target base station (T-BS) in a handover request;

FIG. 9 is a messaging diagram of an example scenario in which a CU transmits an indication of whether a DU is a first type or a second type to a target DU (T-DU) in a UE Context Setup Request;

FIG. 10 is a messaging diagram of an example scenario in which a base station receives an RA preamble and a MAC PDU including a C-RNTI and a handover complete message from a UE, and the base station determines a type of the UE based on the C-RNTI or the RA preamble;

FIG. 11 is a flow diagram of an example method that includes generating a configuration for a UE based on whether the UE is a first type or a second type, which can be implemented in a DU of FIG. 1B;

FIG. 12 is a flow diagram of an example method that includes determining whether a UE is a first type or a second type based on a MAC PDU or an RRC request and generating a downlink control information (DCI) command for the UE based on the type of the UE, which can be implemented in a base station of FIG. 1A;

FIG. 13 is a flow diagram of an example method that includes determining whether a UE is a first type or a second type based on an RA preamble and generating a DCI command for the UE based on the type of the UE, which can be implemented in a base station or a DU of FIGS. 1A-1B;

FIG. 14 is a flow diagram of an example method that includes generating configuration parameters for a UE based on UE capabilities received while communicating with the UE, which can be implemented in a base station or a DU of FIGS. 1A-1B;

FIG. 15 is a flow diagram of an example method for determining a capability of a UE, which can be implemented in a base station of FIG. 1A; and

FIG. 16 is a flow diagram of an example method for informing a base station of a capability of a UE, which can be implemented in a UE of FIG. 1A.

### DETAILED DESCRIPTION OF THE DRAWINGS

Generally speaking, the techniques of this disclosure enable a RAN to determine whether a UE is a reduced capability UE or a normal capability UE.

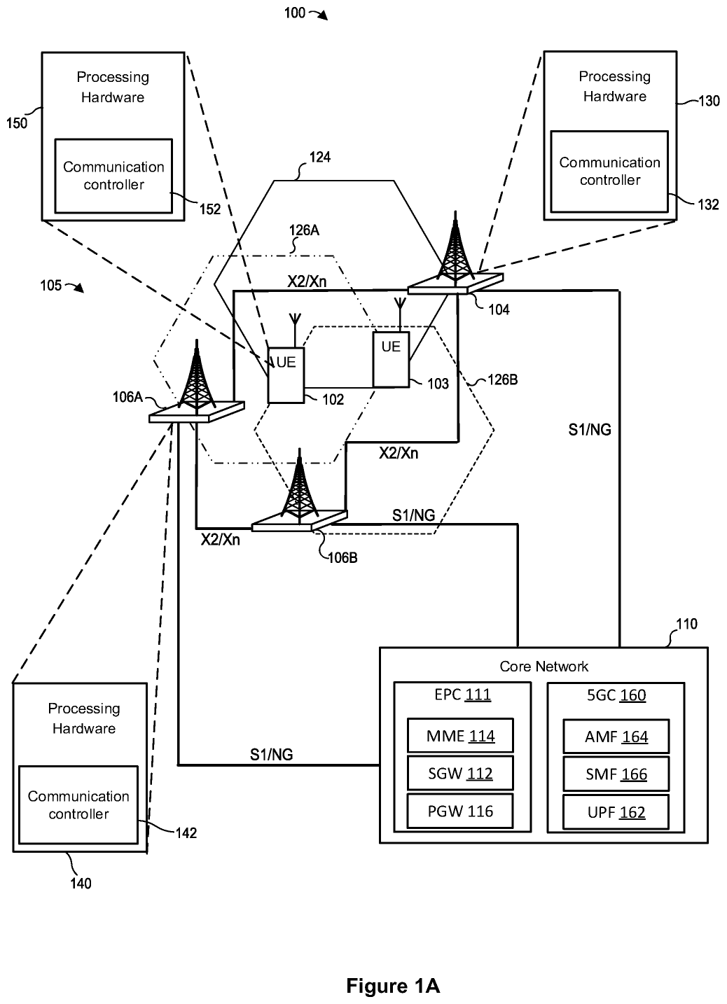

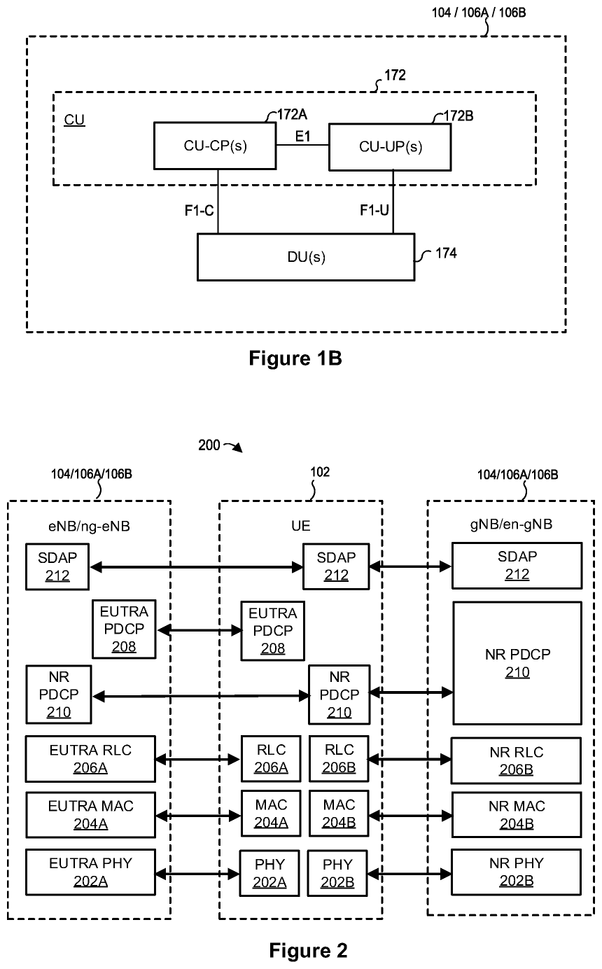

FIG. 1A depicts an example wireless communication system 100 that can communicate with reduced capability and normal capability UEs according to techniques of this disclosure. The wireless communication system 100 includes UE 102 and UE 103, as well as base stations 104, 106A, 106B of a radio access network (RAN) (e.g., RAN 105) that are connected to a core network (CN) 110. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

In an example communication network 100A of FIG. 1A, a UE 102 is a reduced capability UE, and a UE 103 is a normal capability UE. For example, the UE 102 can conform to the reduced capability requirements described in RP-201368, R1-2005233, 3GPP technical report (TR) 38.875, and/or agreements in the RAN 1 #101-e and RAN 1 #102-e meetings. In contrast, the UE 103 can conform to the evolved mobile broadband (eMBB) or ultra-reliable low-latency communication (URLLC) requirements for 5G NR of 3GPP Release 15 or 16 and support a 100 MHz BW in FR1 for bands where 100 MHz channel is available, support a 400 MHz BW in FR2 (if implemented in the UE 103), and/or support four-layer multiple input, multiple output (MIMO) functionality in high bands in FR1. In some embodiments, the UE 102 is a reduced capability UE due to hardware constraints. In other embodiments, the UE 102 includes hardware that can support normal capabilities, but is configured (e.g., by a software setting) to operate with reduced capabilities. Although two UE capability types are discussed throughout this disclosure, the techniques described apply to distinguishing a larger number of UE capability types should they be defined in the future.

The base station 104 supports a cell 124, the base station 106A supports a cell 126A, and the base station 106B supports a cell 126B. The cell 124 partially overlaps with both of cells 126A and 126B, such that the UE 102 or 103 can be in range to communicate with the base station 104 while simultaneously being in range to communicate with the base station 106A or 106B (or in range to detect or measure the signal from both base stations 106A and 106B). The overlap can make it possible for the UE 102 or 103 to hand over between cells (e.g., from the cell 124 to the cell 126A or 126B) or base stations (e.g., from the base station 104 to the base station 106A or base station 106B) before the UE 102 experiences radio link failure, for example. Moreover, the overlap allows the various dual connectivity (DC) scenarios discussed below. For example, the UE 103 can communicate in DC with the base station 104 (operating as an MN) and the base station 106A (operating as an SN) and, upon completing a handover to base station 106B, can communicate with the base station 106B (operating as an MN). As another example, the UE 103 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 103 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

The UE 102 can use a radio bearer (e.g., a DRB or an SRB) that terminates at a base station (e.g., the base station 104). The UE 103 can use a radio bearer (e.g., a DRB or an SRB) that at different times terminates at an MN (e.g., the base station 104) or an SN (e.g., the base station 106A). For example, after handover or SN change to the base station 106B, the UE 102 or 103 can use a radio bearer (e.g., a DRB or an SRB) that at different times terminates at the base station 106B. The UE 102 or 103 can apply one or more security keys when communicating on the radio bearer, in the uplink (from the UE 102 or 103 to a base station) and/or downlink (from a base station to the UE 102 or 103) direction. In communication with a base station, the UE 102 or 103 transmits data via the radio bearer on (i.e., within) an uplink bandwidth part (BWP) of a cell to the base station and/or receives data via the radio bearer on a downlink BWP of the cell from the base station. The uplink BWP can be an initial uplink BWP or a dedicated uplink BWP, and the downlink BWP can be an initial DL BWP or a dedicated downlink BWP.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station communication controller 132 that is configured to communicate with reduced capability UEs and normal capability UEs. For example, the base station communication controller 132 can be configured to support Radio Resource Control (RRC), medium access control (MAC), and physical layer configurations, procedures, and messaging associated with handover procedures, PSCell addition or change procedures, carrier aggregation (CA) configuration procedures, and/or to support the necessary operations, as discussed below.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station communication controller 142 similar to the base station communication controller 132. While not shown in FIG. 1A, the base station 106B can include processing hardware similar to the processing hardware 130 of the base station 104 or the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE communication controller 152 that is configured to manage or control one or more RRC, MAC, and physical layer configurations and/or procedures in accordance with any of the implementations discussed below, when the UE 102 communicates with a base station or communicates with an MN and/or an SN. While not shown in FIG. 1A, the UE 103 can include processing hardware similar to the processing hardware 150 of the base station UE 102. In some scenarios and implementations, the UE 102 may not support CA and/or DC while the UE 103 supports CA and/or DC.

The CN 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

FIG. 1B depicts an example, distributed or disaggregated implementation of any one or more of the base stations 104, 106A, 106B. In this implementation, the base station 104, 106A, or 106B includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The process hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer or a split bearer. The SN-terminated bearer can be an SCG bearer or a split bearer. The MN-terminated bearer can be an SRB (e.g., SRB1 or SRB2) or a DRB. The SN-terminated bearer can be an SRB or a DRB.

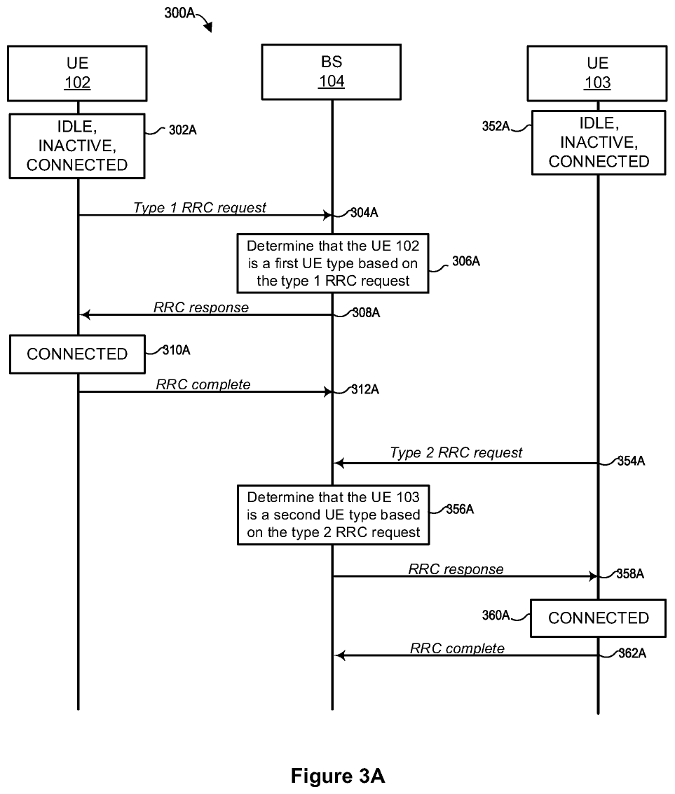

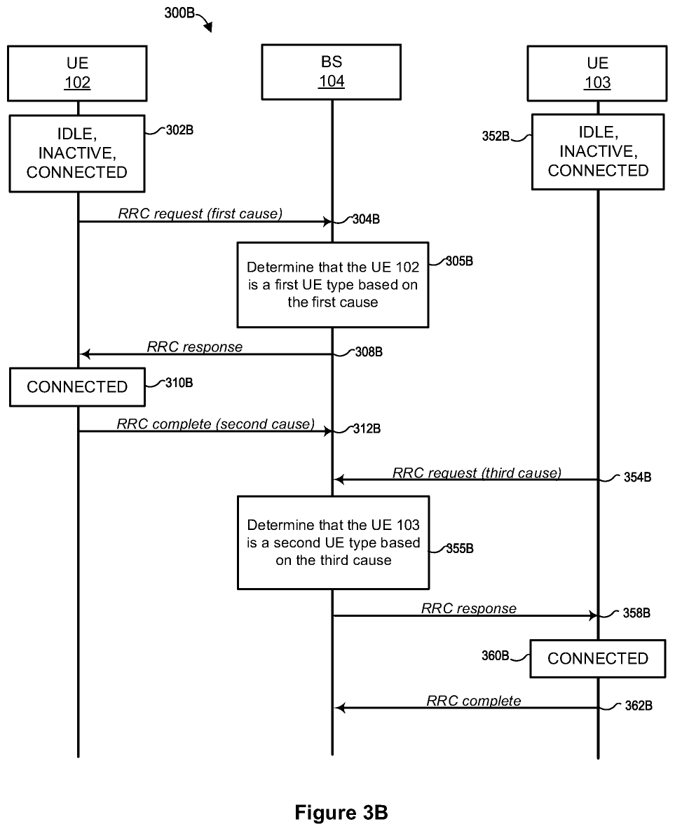

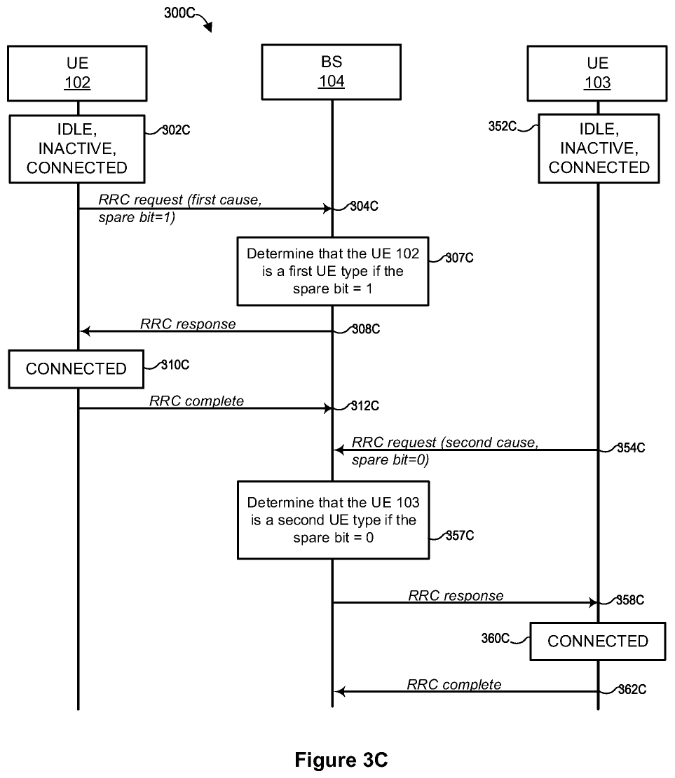

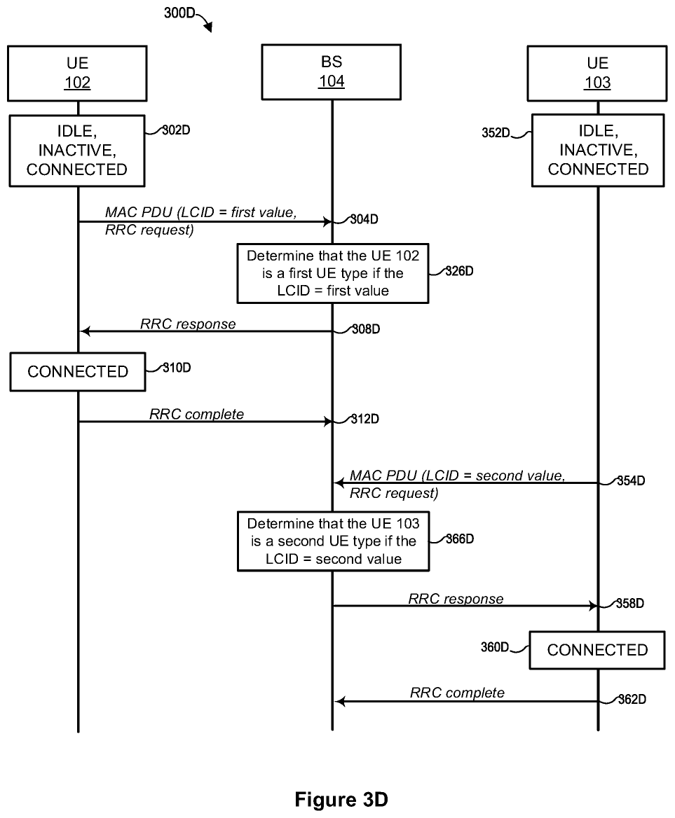

FIGS. 3A-10 are messaging diagrams of example scenarios in which nodes of a RAN identify a capability type of a UE during connection establishment. UE types may correspond to different capability types of UEs. For example, this disclosure refers to reduced capability UEs as a first UE type, and normal capability UEs as a second UE type. Although two UE capability types are discussed throughout this disclosure, the techniques described apply to distinguishing a larger number of UE capability types should they be defined in the future. Generally speaking, events in FIGS. 3A-10 that are similar are labeled with similar reference numbers (e.g., event 302A is similar to event 302B, 302C, 302D, 402A, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Turning first to FIG. 3A, in a scenario 300A the UE 102 initially operates 302A in an idle state (e.g., the RRC_IDLE state), an inactive state (e.g., the RRC_INACTIVE state), a connected state (e.g., the RRC_CONNECTED state) with a failure (e.g., radio link failure), or, more generally, in a state in which there is no active radio connection between the UE 102 and the base station 104. Similarly, the UE 103 initially operates 352A in an idle state (e.g., the RRC_IDLE state), an inactive state (e.g., the RRC_INACTIVE state), a connected state (e.g., the RRC_CONNECTED state) with a failure (e.g., radio link failure), or, more generally, in a state in which there is no active radio connection between the UE 103 and the base station 104. For example, the UE 102/103 can be in an inactive or idle state because before the event 302A/352A, the UE 102/103 in the connected state may receive an RRC suspension message (e.g., an RRCRelease message) from the base station 104 or another base station (e.g., base station 106A). In response to the RRC suspension message, the UE 102/103 suspends the radio connection, and can transition to the inactive state or idle state. In some implementations, the RRC suspension message can include a SuspendConfig IE causing the UE 102/103 to transition to the inactive state. In other implementations, the RRC suspension message can include a new IE causing the UE 102/103 to transition to the idle state with a suspended radio connection.

As mentioned above with respect to FIG. 1A, the UE 102 is a reduced capability UE (i.e., a first UE type), and the UE 103 is a normal capability UE (i.e., a second UE type).

The UE 102 initiates a procedure to establish or restore a radio connection with the base station 104. In particular, the UE 102 may perform a random access procedure with the base station 104. The random access procedure can be a two-step or a four-step procedure. In a four-step procedure between a UE and a base station, the UE transmits to a base station a random access (RA) preamble, which also can be referred to as “Msg1,” to the base station (step 1); the base station transmits a random access response (RAR), or “Msg2,” to the UE (step 2); the UE transmits a scheduled transmission, or “Msg3,” to the base station (step 3); and the base station transmits a contention resolution, or “Msg4,” to the UE (step 4). In a two-step procedure, the UE transmits an RA preamble and a payload, or “MsgA,” to the base station (step 1), and the base station transmits a contention resolution, or “MsgB,” to the UE 102 (step 2). More particularly, the MsgA includes two parts sent on different occasions: the RA preamble transmitted via a PRACH occasion (e.g., similar to Msg1 of the four-step procedure), and the payload transmitted via a PUSCH occasion (e.g., similar to Msg3 of the four-step procedure). Accordingly, both a Msg3 and the payload of a MsgA include payload transmissions on a PUSCH.

While this disclosure describes messaging techniques primarily with reference to RRC Setup, RRC Resume, and RRC Reestablishment procedures, the messaging techniques can apply to any connection establishment procedure, handover procedures, and other suitable procedures. For example, while FIGS. 3A-3D describe methods in which a base station determines a UE capability type based on an RRC request message, a base station can use similar techniques to determine a UE capability type based on a message associated with a handover procedure.

Referring back to FIG. 3A, the UE 102 transmits 304A an RRC request message to the base station 104 during a random access procedure (e.g., as Msg3 of a four-step procedure or MsgA of a two-step procedure; accordingly, the UE 102 also transmits an RA preamble (e.g., as Msg1 or in MsgA), but this is not depicted in FIG. 3A to avoid clutter). If the UE 102 operates 302A in an idle or an inactive state, the RRC request message can signal a transition to a connected state (e.g., an RRCSetupRequest message or an RRCResurneRequest message). If the UE 102 operates 302A in a connected state, the RRC request message can instruct recovery of a radio link failure or other failure (e.g., an RRCReestablishrnentRequest message). Similarly, the UE 103 transmits 354A an RRC request message to the base station 104 during a random access procedure.

However, because the UE 102 is a first UE type, the RRC request message that the UE 102 transmits 304A is a type 1 RRC request message, in this example scenario. In contrast, the UE 103 transmits 354A a type 2 RRC request message.

In an example implementation, the UE 103 uses an UL-CCCH-Message container message or an UL-CCCH1-Message container message to transmit 354A the type 2 RRC request message. The UL-CCCH-Message container can have the following ASN.1 definition:

```
--ASN1START
--TAG-UL-CCCH-MESSAGE-START
UL-CCCH-Message ::= SEQUENCE {
  message UL-CCCH-MessageType
}
UL-CCCH-MessageType ::= CHOICE {
  c1 CHOICE {
    rrcSetupRequest RRCSetupRequest,
    rrcResumeRequest RRCResumeRequest,
    rrcReestablishmentRequest RRCReestablishmentRequest,
    rrcSystemInfoRequest RRCSystemInfoRequest
  },
  messageClassExtension SEQUENCE{ }
}
--TAG-UL-CCCH-MESSAGE-STOP
--ASN1STOP;
```

And the UL-CCCH1-Message container can have the following ASN.1 definition:

```
--ASN1START
--TAG-UL-CCCH1-MESSAGE-START
UL-CCCH1-Message ::= SEQUENCE {
  message UL-CCCH1-MessageType
}
UL-CCCH1-MessageType ::= CHOICE {
  c1 CHOICE {
    rrcResumeRequest1 RRCResumeRequest1,
    spare3 NULL,
    spare2 NULL,
    spare1 NULL
  },
  messageClassExtension SEQUENCE { }
}
--TAG-UL-CCCH1-MESSAGE-STOP
--ASNISTOP
```

On the other hand, the UE 102 can use a different format of a container to transmit 304A a type 1 RRC request message. This container message can be a UL-CCCH-Message formatted in ASN.1 as illustrated below:

--ASN1START
--TAG-UL-CCCH-MESSAGE-START
UL-CCCH-Message ::= SEQUENCE {
message UL-CCCH-MessageType
}

| | |
|---|---|
| UL-CCCH-MessageType ::= | CHOICE { |

```
  c1 CHOICE{ -- Type 2 RRC request
    rrcSetupRequest RRCSetupRequest,
    rrcResumeRequest  RRCResumeRequest,
    rrcReestablishment Request RRCReestablishmentRequest,
    rrcSystemInfoRequest RRCSystemInfoRequest
  },
  messageClassExtension CHOICE { -- Type 1 RRC request
    rrcSetupRequest RRCSetupRequest,
    rrcResumeRequest RRCResumeRequest,
    rrcReestablishmentRequest RRCReestablishmentRequest
}
-- TAG-UL-CCCH-MESSAGE-STOP
-- ASN1STOP;
```

In this implementation, the c1 field corresponds to one type of RRC request messages, and the messageClassExtension field correspond to another type of RRC request messages.

Alternatively, the UE 102 can use a different format of the UL-CCCH1-Message to transmit 304A a type 1 RRC request message. This example format is illustrated below:

```
UL-CCCH1-Message ::=  SEQUENCE {
  message UL-CCCH1-MessageType
}
UL-CCCH1-MessageType ::=  CHOICE {
  c1 CHOICE {
    rrcResumeRequest1 RRCResumeRequest1,
    rrcSetupRequest RRCSetupRequest,
    rrcResumeRequest RRCResumeRequest,
    rrcReestablishmentRequest RRCReestablishmentRequest,
  },
  messageClassExtension SEQUENCE { }
}
-- TAG-UL-CCCH1-MESSAGE-STOP
-- ASN1STOP
```

In this example, the field c/can specify message RRCResurneRequest1 or message RRCResurneRequest.

As yet another alternative, to transmit 304A a type 1 RRC request message, the UE 102 can use the format that may be referred to as UL-CCCH-Message-New, illustrated below in ASN.1:

```
-- ASN1START
-- TAG-UL-CCCH1-MESSAGE-START
UL-CCCH-Message-New ::= SEQUENCE {
  message UL-CCCH-Message-NewType
}
UL-CCCH-Message-NewType ::= CHOICE {
  c1 CHOICE {
    rrcSetupRequestR RCSetupRequest,
    rrcResumeRequest RRCResumeRequest,
    rrcReestablishmentRequest RRCReestablishmentRequest,
    spare 1 NULL
  },
  messageClassExtension SEQUENCE { }
}
-- TAG-UL-CCCH1-MESSAGE-STOP
-- ASN1STOP
```

In this example, a separate container message is defined specifically to convey RRC messages of a different type. Other example suitable names for this container message include UL-CCCH2-Message, UL-CCCH2-Message-RedCap, UL-CCCH-Message-RedCap, UL-CCCH2-Message-RC, and UL-CCCH-Message-RC.

Referring back to FIG. 3A, the base station 104 determines 306A that the UE 102 is a first UE type (e.g., reduced capability UE) based on the type 1 RRC request message. In response to the type 1 RRC request message, the base station 104 transmits 308A an RRC response message to the UE 102. The RRC response message 308A can be an RRCSetup message, an RRCResume message, or an RRCReestablishment message, depending on whether the RRC request message 304A is an RRCSetupRequest message, an RRCResurneRequest message, or an RRCReestablishrnentRequest message. In some implementations, the RRC response message 308A is an RRC reject message (e.g., an RRCReject message) in response to a RRCSetupRequest message or an RRCResurneRequest message. If the RRC response message is neither an RRC reject message nor an RRC suspension message, the UE 102 can transition 310A to the connected state and transmit 312A an RRC complete message to the base station 104, in response to the RRC response message. The RRC complete message can be an RRCSetupComplete message, an RRCResumeComplete message, or an RRCReestablishmentComplete message, in accordance with the RRC response message 308A. If the RRC response message is an RRC reject message or an RRC suspension message, the UE 102 can stay in the original state as event 302A and refrain from transmitting an RRC complete message to the base station 104.

Similarly, the base station 104 determines 356A that the UE 103 is a second UE type (e.g., a normal capability UE or a non-reduced capability UE) based on the type 2 RRC request message. In response to the type 2 RRC request message, the base station 104 transmits 358A an RRC response message to the UE 103. Similar to the RRC response message 308A, the RRC response message 358A can be can be an RRCSetup message, an RRCResume message, or an RRCReestablishment message. In some implementations, the RRC response message 358A is an RRC reject message or an RRC suspension message. If the RRC response message is neither an RRC reject message nor an RRC suspension message, the UE 102 can transition 360A to the connected state and transmit 362A an RRC complete message to the base station 104. The RRC complete message can be an RRCSetupComplete message, an RRCResumeComplete message, or an RRCReestablishmentComplete message, in accordance with the RRC response message 358A. If the RRC response message is an RRC reject message or an RRC suspension message, the UE 103 can stay in the original state as event 352A and refrain from transmitting an RRC complete message to the base station 104.

After identifying 306A the UE 102 as a first UE type, the base station 104 can generate configuration parameters that a reduced capability UE supports for the UE 102. The base station 104 can transmit 308A such configuration parameters to the UE 102 in the RRC response message, or in a different message (e.g., an RRC reconfiguration message after the RRC response message). Similarly, the base station 104 can generate configuration parameters that a normal capability UE supports for the UE 103, and can transmit 358A such configuration parameters to the UE 103 in the RRC response message or in a different message (e.g., an RRC reconfiguration message after the RRC response message). More generally, the base station 104 can communicate with the UE 102 in a manner suitable for a reduced capability UE (i.e., in accordance with one or more predetermined reduced capabilities of a first UE type), and with the UE 103 in a manner suitable for a normal capability UE.

In some implementations, the base station 104 can generate a first downlink control information (DCI) including configuration parameters that a UE is to use for receiving downlink transmissions and transmitting uplink transmissions. Based on the determination 306A, the base station 104 can generate configuration parameters conforming to predetermined reduced capabilities of a reduced capability UE or, more generally, parameters that a reduced capability UE should support. The base station 104 can transmit the first DCI to the UE 102 before transmitting 308A the RRC response message, such that the UE 102 can configure itself to receive 308A the RRC response message in accordance with the first DCI. Likewise, based on the determination 356, the base station 104 can generate a second DCI for the UE 103 that includes parameters that a normal capability UE supports. The base station 104 can transmit the second DCI to the UE 103 before transmitting 358A the RRC response message.

As one example, the base station 104 can include in the first DCI parameters scheduling a PDSCH transmission to the UE 102, where the PDSCH transmission can include the RRC response message 308A. The parameters can include a first time domain resource assignment field and/or a first frequency domain resource assignment field for the PDSCH transmission. In one implementation, the base station 104 sets the first time domain resource assignment field to a first value conforming to one or more predetermined reduced capabilities of a reduced capability UE. In another implementation, the base station 104 sets the first time domain resource assignment field to a first predetermined value. In one implementation, the base station 104 sets the first frequency domain resource assignment field to a first value conforming to the one or more predetermined reduced capabilities of a reduced capability UE. In another implementation, the base station 104 sets the first frequency domain resource assignment field to a first predetermined value. In such implementations, the UE 102 receives the PDSCH transmission at time domain resources (e.g., symbols) in accordance with the first time domain resource assignment field, and/or in frequency domain resources in accordance with the first frequency domain resource assignment field.

In some implementations, the base station 104 can include a first PDSCH-to-HARQ feedback timing indicator in the first DCI. In one implementation, the base station 104 sets the first PDSCH-to-HARQ feedback timing indicator to a first value conforming to the one or more predetermined reduced capabilities of a reduced capability UE. Thus, the UE 102 can transmit a HARQ feedback in accordance with the first value. In another implementation, the base station 104 sets the first PDSCH-to-HARQ feedback timing indicator to a predetermined value. The HARQ feedback can be a HARQ acknowledgement or a HARQ negative acknowledgement.

Similarly, the base station 104 can include in the second DCI parameters scheduling a PDSCH transmission to the UE 103, where the PDSCH transmission can include the RRC response message 358A. The parameters can include a second time domain resource assignment field and/or a second frequency domain resource assignment field for the PDSCH transmission. In one implementation, the base station 104 sets the second time domain resource assignment field to a second value conforming to the one or more predetermined normal capabilities of a normal capability UE. In another implementation, the base station 104 sets the second time domain resource assignment field to a second predetermined value. In yet another implementation, the base station 104 sets the second time domain resource assignment field to the same value as the first time domain resource assignment field. In one implementation, the base station 104 sets the second frequency domain resource assignment field to a second value conforming to the one or more predetermined normal capabilities. In another implementation, the base station 104 sets the second frequency domain resource assignment field to a second predetermined value. In yet another implementation, the base station 104 sets the second frequency domain resource assignment field to the same value as the first time domain resource assignment field. In such implementations, the UE 103 receives the PDSCH transmission at time domain resources (e.g., symbols) in accordance with the second time domain resource assignment field, and/or in frequency domain resources in accordance with the second frequency domain resource assignment field.

In some implementations, the base station 104 can include a second PDSCH-to-HARQ feedback timing indicator in the second DCI. In one implementation, the base station 104 sets the second PDSCH-to-HARQ feedback timing indicator to a second value conforming to the one or more predetermined normal capabilities. For example, the second value may correspond to an earlier time resource compared to the first PDSCH-to-HARQ feedback timing indicator because the UE 103 is capable of processing the PDSCH transmission more quickly than the UE 102. The UE 103 can transmit a HARQ feedback in accordance with the second value. In another implementation, the base station 104 sets the second PDSCH-to-HARQ feedback timing indicator the same value as the first PDSCH-to-HARQ feedback timing indicator. The HARQ feedback can be a HARQ acknowledgement or a HARQ negative acknowledgement.

In some implementations, the base station 104 transmits the first DCI on a time and frequency resource. The time and frequency resource can be on a first control resource set (CORESET) or a first search space. The base station 104 can broadcast a first system information block (SIB) including first configuration parameters configuring the first CORESET or first search space. The UE 102 receives the first SIB, and receives the first DCI on the time and frequency resource on the first CORESET or first search space in accordance with the first configuration parameters. In other implementations, the base station 104 can transmit the second DCI on a time and frequency resource. The time and frequency resource can be on a second control resource set (CORESET) or a second search space. The base station 104 can broadcast a second SIB including second configuration parameters configuring the CORESET or search space. The UE 103 receives the second SIB, and receives the second DCI on the time and frequency resource on the second CORESET or second search space in accordance with the second configuration parameters. The first and second SIBs can be the same SIB or different SIBs. The first and second CORESETs can be the same CORESET or different CORESETs. The first and second search spaces can be the same search space or different search spaces.

In some implementations, the base station 104 can broadcast a third SIB including a first PUCCH configuration (e.g., PUCCH-ConfigCommon IE, PUCCH-ConfigCommon-RedCap IE or PUCCH-ConfigCornrnon-RC IE) that configures PUCCH resource(s) for UEs of the first type. The UE 102 transmits the HARQ feedback on a first PUCCH resource configured by the first PUCCH configuration. The UE 102 can determine the first PUCCH resource based on a PUCCH resource indicator in the first DCI. The base station 104 can include a second PUCCH configuration in the second SIB or alternatively broadcast a fourth SIB including the second PUCCH configuration (e.g., PUCCH-ConfigCommon IE) that configures PUCCH resource(s) for UEs of the second type. The UE 103 transmits the HARQ feedback on a second PUCCH resource configured by the second PUCCH configuration. The UE 103 can determine the first PUCCH resource according to a PUCCH resource indicator in second DCI. In some implementations the PUCCH resource(s) configured in the first and second PUCCH configurations are exclusive. In other implementations, at least one PUCCH resource configured in the first and second PUCCH configurations are the same. The remainder in the first and second PUCCH configurations can be the same or different. In this case, the base station 104 does not configure more than one UE to transmit HARQ feedback on the same PUCCH resource in the same time instance.

In other implementations, the base station 104 can broadcast a third SIB (e.g., SIB1) including a PUCCH configuration (e.g., PUCCH-ConfigCommon IE) that configures PUCCH resource(s) for the first type UEs and the second type UEs. In this case, the base station 104 does not configure more than one UE to transmit HARQ feedback on the same PUCCH resource in the same time instance. The UE 102 transmits the HARQ feedback on a first PUCCH resource configured by the first PUCCH configuration. The UE 103 transmits the HARQ feedback on a second PUCCH resource configured by the second PUCCH configuration.

In some implementations, the RRC response message 308A and the RRC response message 358A are the same type. For example, both the UE 102 and the UE 103 can use a DL-CCCH-Message container message or a DL-DCCH-Message container message to transmit 308A/358A the RRC response message. The DL-CCCH-Message container can have the following ASN.1 definition:

```
-- ASN1START
-- TAG-DL-CCCH-MESSAGE-START
DL-CCCH-Message::= SEQUENCE {
  message DL-CCH-MessageType
}
DL-CCCH-MessageType ::= CHOICE {
  c1  CHOICE {
    rrcReject RRCReject,
    rrcSetup RRCSetup,
    spare2 NULL,
    spare1 NULL
  },
  messageClassExtension SEQUENCE { }
}
-- TAG-DL-CCCH-MESSAGE-STOP
-- ASN1STOP
```

And the DL-DCCH-Message container can have the following ASN.1 definition:

```
-- ASN1START
-- TAG-DL-DCCH-MESSAGE-START
DL-DCCH-Message ::= SEQUENCE {
  message DL-DCCH-MessageType
}
DL-DCCH-MessageType ::= CHOICE {
  c1 CHOICE {
      rrcReconfiguration RRCReconfiguration,
      rrcResume RRCResume,
      rrcRelease RRCRelease,
      rrcReestablishment RRCReestablishment,
      securityModeCommand SecurityModeCommand,
      dlInformationTransfer DLInformationTransfer,
      ueCapabilityEnquiry UECapabilityEnquiry,
      counterCheck CounterCheck,
      mobilityFromNRCommand MobilityFromNRCommand,
      dlDedicatedMessageSegment-r16 DLDedicatedMessageSegment-r16,
      ueInformationRequest-r16 UEInformationRequest-r16,
      dlInformationTransferMRDC-r16 DLInformationTransferMRDC-r16,
      loggedMeasurementConfiguration-r16 LoggedMeasurementConfiguration-r16,
          spare3 NULL, spare2 NULL, spare1 NULL
  },
  messageClassExtension SEQUENCE { }
}
-- TAG-DL-DCCH-MESSAGE-STOP
-- ASN1STOP
```

On the other hand, in some implementations, the UE 103 can use a DL-CCCH-Message container message or a DL-DCCH-Message a container message to transmit 358A the RRC response message, and the UE 102 can use a different format of a container to transmit 308A the RRC response message. In such implementations, the container message that the UE 102 transmits 308A can be a DL-CCCH-Message-New or a DL-DCCH-Message-New container. In an example implementation, the DL-CCCH-Message-New can have the following ASN.1 definition:

```
-- ASN1START
-- TAG-DL-CCCH-MESSAGE-START
DL-CCCH-Message-New ::= SEQUENCE {
  message DL-CCCH-Message-NewType
}
DL-CCCH-Message-NewType ::= CHOICE {
  cl CHOICE {
    rrcReject RRCReject,
    rrcSetup RRCSetup,
    spare2 NULL,
    spare1 NULL
  },
  messageClassExtension SEQUENCE { }
}
-- TAG-DL-CCCH-MESSAGE-STOP
-- ASN1STOP
```

And the DL-DCCH-Message-New container can have the following ASN.1 definition:

```
-- ASN1START
-- TAG-DL-CCCH-MESSAGE-START
DL-CCCH-Message-New ::= SEQUENCE {
  message DL-CCCH-Message-NewType
}
DL-CCCH-Message-NewType ::= CHOICE {
  cl CHOICE {
    rrcResume RRCResume,
    rrcReestablishment RRCReestablishment,
    spare2 NULL, spare1 NULL
  },
  messageClassExtension SEQUENCE { }
}
-- TAG-DL-CCCH-MESSAGE-STOP
-- ASN1STOP
```

Other example suitable names for the DL-CCCH-Message-New container message include DL-CCCH1-Messsage, DL-CCCH1-Messsage-RedCap, DL-CCCH-Message-RedCap, DL-CCCH1-Messsage-RC, and DL-CCCH-Message-RC. Other example suitable names for the DL-DCCH-Message-New container message include DL-DCCH1-Messsage, DL-DCCH1-Messsage-RedCap, DL-DCCH-Message-RedCap, DL-DCCH1-Messsage-RC, and DL-DCCH-Message-RC.

Similarly, in some implementations, the RRC complete message 312A and the RRC complete message 362A are the same type. For example, both the UE 102 and the UE 103 can use an UL-DCCH-Message container message to transmit 312A/362A the RRC complete message. The UL-DCCH-Message container can have the following ASN.1 definition:

```
-- ASN1START
-- TAG-UL-DCCH-MESSAGE-START
UL-DCCH-Message ::= SEQUENCE {
    message UL-DCCH-MessageType
}
UL-DCCH-MessageType ::= CHOICE {
    c1 CHOICE {
```

| | |
|---|---|
| measurementReport | MeasurementReport, |
| rrcReconfigurationComplete | RRCReconfigurationComplete, |
| rrcSetupComplete | RRCSetupComplete, |
| rrcReestablishmentComplete | RRCReestablishmentComplete, |
| rrcResumeComplete | RRCResumeComplete, |
| securityModeComplete | SecurityModeComplete, |
| securityModeFailure | SecurityModeFailure, |
| ulInformationTransfer | ULInformationTransfer, |
| locationMeasurementIndication | LocationMeasurementIndication, |
| ueCapabilityInformation | UECapabilityInformation, |
| counterCheckResponse | CounterCheckResponse, |
| ueAssistanceInformation | UEAssistanceInformation, |

failureInformation FailureInformation,

| | |
|---|---|
| ulInformationTransferMRDC | ULInformationTransferMRDC, |

scgFailureInformation SCGFailureInformation,

| | |
|---|---|
| scgFailureInformationEUTRA | SCGFailureInformationEUTRA |
| }, | |

messageClassExtension CHOICE {

| | |
|---|---|
| c2 CHOICE { | |
| ulDedicatedMessageSegment-r16 | ULDedicatedMessageSegment-r16, |
| dedicatedSIBRequest-r16 | DedicatedSIBRequest-r16, |
| mcgFailureInformation-r16 | MCGFailureInformation-r16, |
| ueInformationResponse-r16 | UEInformationResponse-r16, |
| sidelinkUEInformationNR-r16 | SidelinkUEInformationNR-r16, |
| ulInformationTransferIRAT-r16 | ULInformationTransferIRAT-r16, |

```
      iabOtherInformation-r16 IABOtherInformation-r16,
      spare9 NULL, spare8 NULL, spare7 NULL, spare6 NULL,
      spare5 NULL, spare4 NULL, spare3 NULL, spare2 NULL, spare1 NULL
```

| | |
|---|---|
| }, | |
| messageClassExtensionFuture-r16 | SEQUENCE { } |
| } | |
| } | |
| -- TAG-UL-DCCH-MESSAGE-STOP | |
| -- ASNISTOP | |

On the other hand, in some implementations, the UE 103 can use a UL-DCCH-Message container message to transmit 362A the RRC complete message, and the UE 102 can use a different format of a container to transmit 312A the RRC complete message. In such implementations, the container message that the UE 102 transmits 312A can be a UL-DCCH-Message-New. In an example implementation, the DL-CCCH-Message-New can have the following ASN.1 definition:

```
-- ASN1START
-- TAG-UL-DCCH-MESSAGE-START
UL-DCCH-Message-New::= SEQUENCE {
    message UL-DCCH-MessageType
}
UL-DCCH-MessageType ::= CHOICE {
    c1 CHOICE {
      measurementReport MeasurementReport,
      rrcReconfigurationComplete  RRCReconfigurationComplete,
      rrcSetupComplete RRCSetupComplete,
      rrcReestablishmentComplete  RRCReestablishmentComplete,
      rrcResumeComplete RRCResumeComplete,
      securityModeComplete SecurityModeComplete,
      securityModeFailure SecurityModeFailure,
      ulInformationTransfer ULInformationTransfer,
      locationMeasurementIndication  LocationMeasurementIndication,
      ueCapabilityInformation UECapabilityInformation,
      counterCheckResponse CounterCheckResponse,
      ueAssistanceInformation UEAssistanceInformation,
      failureInformation Failure Information,
```

| | |
|---|---|
| ulInformationTransferMRDC | ULInformationTransferMRDC, |

scgFailureInformation SCGFailureInformation,

| | |
|---|---|
| scgFailureInformationEUTRA | SCGFailureInformationEUTRA |
| }, | |

messageClassExtension CHOICE {

| | |
|---|---|
| c2 CHOICE { | |
| ulDedicatedMessageSegment-r16 | ULDedicatedMessageSegment-r16, |
| dedicatedSIBRequest-r16 | DedicatedSIBRequest-r16, |
| mcgFailureInformation-r16 | MCGFailureInformation-r16, |
| ueInformationResponse-r16 | UEInformationResponse-r16, |
| sidelinkUEInformationNR-r16 | SidelinkUEInformationNR-r16, |
| ulInformationTransferIRAT-r16 | ULInformationTransferIRAT-r16, |

```
      iabOtherInformation-r16 IABOtherInformation-r16,
      spare9 NULL, spare8 NULL, spare7 NULL, spare6 NULL,
      spare5 NULL, spare4 NULL, spare3 NULL, spare2 NULL, spare1 NULL
```

| | |
|---|---|
| }, | |
| messageClassExtensionFuture-r16 | SEQUENCE { } |
| } | |
| } | |
| -- TAG-UL-DCCH-MESSAGE-STOP | |
| -- ASNISTOP | |

Other example suitable names for the UL-DCCH-Message-New container message include UL-DCCH1-Message, UL-DCCH1-MessageRedCap, UL-DCCH-Message-RedCap, UL-DCCH1-Message-RC, and UL-DCCH-Message-RC. In some implementations, RRC messages other than the RRC complete messages (e.g., RRC messages other than RRCSetupComplete, RRCResumeComplete, or RRCReestablishmentComplete), such as IABOtherInformation-r16, may be omitted from the UL-DCCH-Message-New container message.

FIG. 3B illustrates a scenario 300B similar to the scenario 300A of FIG. 3A. In the scenario 300B, the base station 104 determines whether a UE is a first UE type or a second UE type (i.e., a reduced capability UE or a normal capability UE), based on a type of RRC request message that the base station receives from the UE. In contrast, in scenario 300B, the base station 104 determines whether a UE is a first UE type or a second UE type based on a cause included in an RRC request message.

Events in the scenario 300B similar to those discussed above with respect to the scenario 300A are labeled with similar reference numbers (e.g., with event 302A of FIG. 3A corresponding to event 302B of FIG. 3B). With the exception of the differences shown in FIG. 3B and the differences described below, any of the alternative implementations discussed above with respect to the scenario 300A (e.g., for messaging and processing) may apply to the scenario 300B.

In some scenarios and implementations, the UE 102 in the idle or inactive state transmits 304B an RRC request message including a first cause to the base station 104 to transition to the connected state. In other scenarios and implementations, the UE 102 in the connected state with a failure transmits 304B an RRC request message including a first cause to the base station 104 to recover the failure. As in scenario 300A, the UE 102 transmits 304B the RRC request message during a random access procedure. The base station 104 determines 306B that the UE 102 is a first type UE (e.g., reduced capability UE) based on the first cause. The base station 104 transmits 308B an RRC response message to the UE 102 in response to the RRC request message. If the RRC response message is neither an RRC reject message (e.g., RRCReject) nor an RRC suspension message, the UE 102 can transition 310B to the connected state and transmit 312B an RRC complete message including a second cause to the base station 104, in response to the RRC response message. If the RRC response message is an RRC reject message (e.g., RRCReject) or an RRC suspension message, the UE 102 can stay in the original state as event 302B and refrain from transmitting an RRC complete message to the base station 104.

In other scenarios and implementations, the UE 103 in the idle or inactive state transmits 354B an RRC request message including a third cause to the base station 104 to transition to the connected state. In other scenarios and implementations, the UE 102 in the connected state with a failure transmits 354B an RRC request message including a third cause to the base station 104 to recover the failure. The base station 104 determines 355B that the UE 103 is a second type UE (e.g., normal capability UE) based on the third cause. The base station 104 transmits 358B an RRC response message to the UE 102 in response to the RRC request message. If the RRC response message is neither an RRC reject message (e.g., RRCReject) nor an RRC suspension message, the UE 103 can transition 360B to the connected state and transmit 362B an RRC complete message to the base station 104, in response to the RRC response message. If the RRC response message is an RRC reject message (e.g., RRCReject) or an RRC suspension message, the UE 103 can stay in the original state as event 352B and refrain from transmitting an RRC complete message to the base station 104.

In some implementations, the first cause is a “fake” cause or a spare value used by the UE 102 to indicate that the UE 102 is the first UE type. More particularly, the RRC request may include a cause field conventionally used by the UE to indicate the cause for initiating the RRC procedure. For example, the cause field may be an establishmentCause field in an RRCSetupRequest message, a resumeCause field in an RRCResumeRequest message, or a reestablishmentCause field in an RRCReestablishmentCause. To inform the base station that the UE 102 is a first UE type, the UE 102 can include the first cause in the cause field, where the first cause is a “dummy” cause (i.e., an indication that the UE 102 is the first UE type rather than a cause for initiating the RRC procedure). In some implementations, a spare value reserved for establishment, resume, or reestablishment causes can be replaced or renamed with the first cause. The base station 104 can determine 305B that the UE 102 is the first type of UE 102 based on receiving the first cause in the cause field as opposed to receiving 355B the third cause in the cause field. The UE 102 can transmit 312B the RRC complete message including the second cause, where the second cause corresponds to the “real” cause (e.g., an establishment cause, a resume cause, or a reestablishment cause) for initiating the RRC procedure. Example establishment causes include emergency, highPriorityAccess, mt-Access, mo-Signalling, mo-Data, mo-VoiceCall, mo-VideoCall, mo-SMS, mps-PriorityAccess or mcs-PriorityAccess. Example resume causes include emergency, highPriorityAccess, mt-Access, mo-Signalling, mo-Data, mo-VoiceCall, mo-VideoCall, mo-SMS, ma-Update, mps-PriorityAccess, mcs-PriorityAccess. Example reestablishment causes include reconfigurationFailure, handoverFailure or otherFailure.

The third cause that the UE 103 transmits 354B in the RRC request message can be a “real” cause similar to the second cause. Although three causes are shown in FIG. 3B, including one “fake” cause, the number of causes may be increased to distinguish a larger number of UE capability types.

In some implementations, the UE 102 transmits 304B a first container message including the RRC request message to the base station 104. In some implementations, the RRC request message can be an RRCSetupRequest, an RRCResurneRequest, or an RRCReestablishrnentRequest message. Similarly, the UE 103 transmits 354B a second container message including the RRC request message to the base station 104. In some implementations, the RRC request message can be an RRCSetupRequest, an RRCResurneRequest, or an RRCReestablishrnentRequest message. In some implementations, the first and second container messages can be a UL-CCCH-Message formatted in ASN.1 as illustrated above.

Turning to FIG. 3C, a scenario 300C is similar to the scenarios 300A and 300B. In the scenario 300C, the base station 104 determines whether a UE is a first UE type or a second UE type based on a spare bit included in an RRC request received from the UE. Events in the scenario 300C similar to those discussed above with respect to the scenarios 300A-B are labeled with similar reference numbers (e.g., with event 302A of FIG. 3A corresponding to event 302C of FIG. 3C). With the exception of the differences shown in FIG. 3C and the differences described below, any of the alternative implementations discussed above with respect to the scenarios 300A-B (e.g., for messaging and processing) may apply to the scenario 300C.

In the scenario 300C, the UE 102 transmits 304C an RRC request to the base station 104. The RRC request may be similar to the RRC request the UE 102 transmits 304B. However, to indicate to the base station 104 that the UE 102 is a first UE type, the UE 102 uses a spare bit (i.e., a currently unassigned field) in the RRC request message. For example, the spare bit may be renamed to a suitable field name, such as “RedCap.” The UE 102 can flag to the base station 104 that the UE 102 is a first UE type by setting the spare bit in the RRC request to “1.” The base station 104 can then determine 307C that the UE 102 is a first UE type if the spare bit is set to 1. The RRC request message may also include a first cause, where the first cause indicates a cause for initiating the RRC procedure, similar to the second cause of FIG. 3B.

Similarly, the UE 103 can transmit 354C an RRC request to the base station 104. To indicate to the base station 104 that the UE 102 is a second UE type, the UE 103 can set the spare bit to “0” (i.e., the UE 103 can refrain from changing the spare bit from the 0 default value). The base station 104 can determine 357C that the UE 103 is the second UE type if the spare bit is set to 0. The RRC request may also include a second cause, where the second cause indicates a cause for initiating the RRC procedure, similar to the third cause of FIG. 3B.

Turning to FIG. 3D, a scenario 300D is similar to the scenarios 300A-C. In the scenario 300D, the UE 102 transmits a MAC PDU to the base station 104 in order to establish a connection with the base station 104. The base station 104 determines whether a UE is a first UE type or a second UE type based on a logical channel identity (LCID) in the MAC PDU. Events in the scenario 300D similar to those discussed above with respect to the scenarios 300A-C are labeled with similar reference numbers (e.g., with event 302A of FIG. 3A corresponding to event 302D of FIG. 3D). With the exception of the differences shown in FIG. 3D and the differences described below, any of the alternative implementations discussed above with respect to the scenarios 300A-C (e.g., for messaging and processing) may apply to the scenario 300D.

In the scenario 300D, the UE 102 transmits 304D a MAC PDU including an LCID and an RRC request message (e.g., an RRCResurneRequest message, an RRCSetupRequest message, or an RRCReestablishrnentRequest message, similar to the RRC request message the UE transmits at events 304A-C) to the base station 104. The UE 102 uses a value for the LCID corresponding to a first value. In some implementations, the first value is a default or predetermined value for the UE 102 because the UE 102 is a reduced capability UE. In other implementations, the UE 102 selects the first value for the LCID in order to inform the base station 104 that the UE 102 is a reduced capability UE. Based on receiving the LCID set to the first value, the base station 104 determines 326D that the UE 102 is a first UE type (i.e., a reduced capability UE). In some implementations, the first value can be one of numbers 35, 36, . . . , 44.

Similarly, the UE 103 transmits 354D a MAC PDU including an LCID and an RRC request message to the base station 104. The UE 103 uses a value for the LCID corresponding to a second value. In some implementations, the second value is a default or predetermined value for the UE 103 because the UE 103 is a normal capability UE. In other implementations, the UE 103 selects the second value for the LCID in order to inform the base station 104 that the UE 103 is a normal capability UE. Based on receiving the LCID set to the second value, the base station 104 determines 366D that the UE 103 is a second UE type (i.e., a normal capability UE). In some implementations, the second value can be 0 or 52.

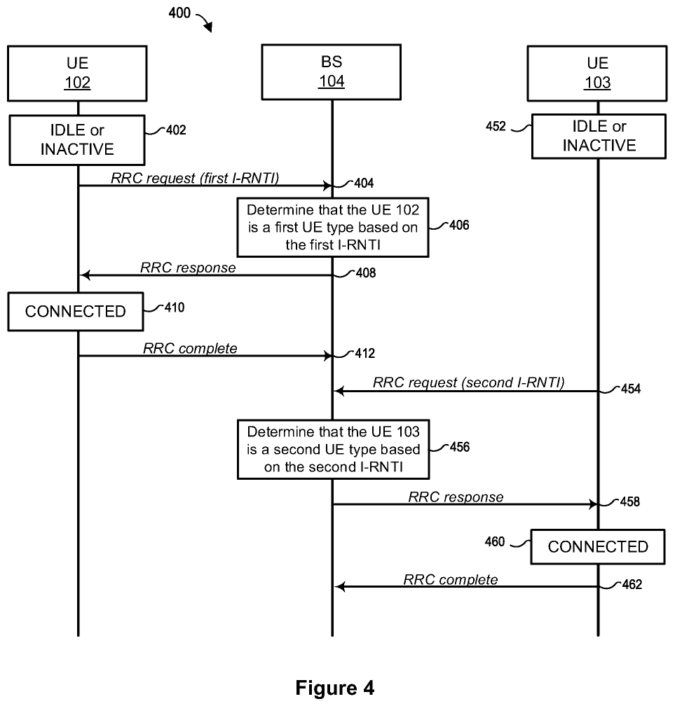

FIG. 4 illustrates a scenario 400 similar to the scenarios 300A-D of FIGS. 3A-3D In the scenario 400, a base station determines whether a UE is a reduced capability UE or a normal capability UE based on an Inactive Radio Network Temporary Identifier (I-RNTI) that the base station receives from the UE. Events in the scenario 400 similar to those discussed above with respect to the scenarios 300A-D are labeled with similar reference numbers. With the exception of the differences shown in FIG. 4 and the differences described below, any of the alternative implementations discussed above with respect to the scenarios 300A-D (e.g., for messaging and processing) may apply to the scenario 400.

In particular, the events 408, 410, 412, 458, 460, and 462 are similar to the events 308A-D, 310A-D, 312A-D, 358A-D, 360A-D, and 362A-D, respectively. In contrast to the events 302A-D, the UE 102 initially operates 402 in the idle or the inactive state, rather than the idle, inactive, or connected state. Similarly, the UE 103 initially operates 452 in the idle or the inactive state.

In some scenarios and implementations, the UE 102 in the idle or inactive state initiates an RRC resume procedure by transmitting 404 an RRC request message including a first I-RNTI to the base station 104 to transition to the connected state. The base station 104 determines 406 that the UE 102 is a first UE type (e.g., reduced capability UE) based on the first I-RNTI. In other scenarios and implementations, the UE 103 in the idle or inactive state initiates an RRC procedure by transmitting 454 an RRC request message including a second I-RNTI to the base station 104 to transition to the connected state. The base station 104 determines 456 that the UE 103 is a second UE type (e.g., normal capability UE) based on the second I-RNTI.

In some implementations, prior to the scenario 400, the UE 102 operates in the connected state with a base station (e.g., the base station 104 or another base station, such as the base station 106A). For clarity, the following discussion of events prior to the scenario 400 refers to the base station 106A as previously connected to the UE 102. The UE 102 in the connected state may receive a first RRC suspension message (e.g., an RRCRelease message) from the base station 106A. The base station 106A can include the first I-RNTI for the UE 102 in the first RRC suspension message (not shown). In response to the first RRC suspension message, the UE 102 suspends the radio connection, and can transition to the inactive state or idle state. In some implementations, the first RRC suspension message can include a SuspendConfig IE that causes the UE 102 to transition to the inactive state. In other implementations, the first RRC suspension message can include a new IE that causes the UE 102 to transition to the idle state with suspended radio connection. Likewise, prior to the scenario 400, the UE 103 in some implementations operates in the connected state with a base station (e.g., the base station 104 or another base station, such as the base station 106A), and the base station can include the second I-RNTI for the UE 103 in a second RRC suspension message (not shown).

In such implementations, the base station 106A that transmits the first I-RNTI to the UE 102 may be aware that the UE 102 is a reduced capability UE. In one example, the base station 106A may use any of the techniques discussed above with reference to FIGS. 3A-3D to determine that the UE 102 is a reduced capability UE. As another example, the base station 106A receives a UE capability information element (IE) of the UE 102 that indicates that the UE 102 is the first UE type, and the base station 106A determines that the UE 102 is the first UE type based on the UE capability IE. The base station 106A may receive the UE capability IE from the UE 102 in a UECapabilityInformation message, from another base station in an Xn interface message, or from the CN 110 in an NG interface message.

Accordingly, before transmitting the first I-RNTI to the UE 102, the base station 106A can associate the first I-RNTI with the first UE type. In some implementations, the base station 106A can assign the UE 102 the first I-RNTI from a first subset of I-RNTI values, where the first subset of I-RNTI values are associated with reduced capability UEs by the RAN. For example, the base station 106A can select the first I-RNTI from a predetermined range of I-RNTI values allocated for the first UE type. In other implementations, the base station 106A can assign an I-RNTI and record (e.g., in a table) that the I-RNTI is associated with a reduced capability UE. The base station 104 can therefore determine 406 that the first I-RNTI received from the UE 102 is associated with a reduced capability UE (e.g., because the first I-RNTI maps to a first subset of values associated with reduced capability UEs, or because a table or record stored at the base station 104, which the base station 104 may receive from the base station 106A, maps the first I-RNTI to a reduced capability UE).

Likewise, the base station 106A that transmits the second I-RNTI to the UE 103 may be aware that the UE 103 is a normal capability UE (e.g., using any of the techniques discussed above with reference to FIGS. 3A-3D or based on a UE capability IE of the UE 103). Accordingly, the base station 106A can associate the second I-RNTI with the second UE type. The base station 106A can assign the UE 103 the second I-RNTI from a second subset of I-RNTI values, where the second subset of I-RNTI values are associated with normal capability UEs by the RAN. For example, the base station 106A can select the second I-RNTI from a predetermined range of I-RNTIs allocated for the second UE type. Alternatively, the base station 106A can assign an I-RNTI and record (e.g., in a table) that the I-RNTI is associated with a normal capability UE. The base station 104 can therefore determine 456 that the second I-RNTI received from the UE 103 is associated with a normal capability UE (e.g., because the second I-RNTI maps to a second subset of values associated with normal capability UEs, or because a table or record stored at the base station 104, which the base station 104 may receive from the base station 106A, maps the second I-RNTI to a normal capability UE).

In some scenarios and implementations, the base station 104 sends a Retrieve UE Context Request message to the base station 106A in response to the RRC request message 404. In response to the Retrieve UE Context Setup Request message, the base station 106A transmits a Retrieve UE Context Response message including the UE capability information IE to the base station 104. Thus, the base station 104 can determine 406 that the UE 102 is the first UE type based on the UE capability IE of the UE 102. In a similar manner, the base station 104 can determine 456 that the UE 103 is the second UE type based on a UE capability IE of the UE 103 received from the base station 106A.

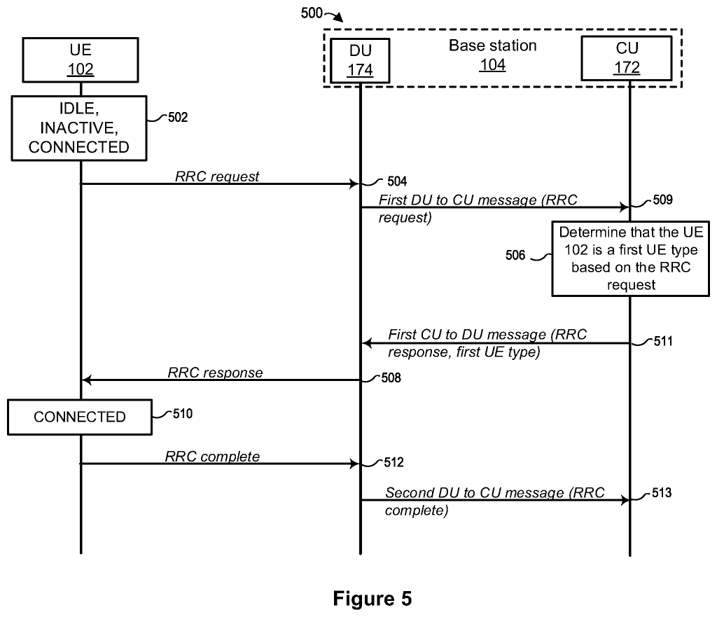

Turning to FIG. 5, a scenario 500 is similar to the scenarios 300A-D and 400. In particular, FIG. 5 illustrates additional messaging between a CU and a DU of a base station that may take place during any of the scenarios 300A-D and 400. The UE 102 transmits 504 an RRC request message to the base station 104, similar to the RRC request message that the UE 102 transmits at events 304A-D and 404. The base station 104, which includes a DU 174 and a CU 172, receives 504 the RRC request message at the DU 174. The DU 174 transmits 509 the RRC request message to a CU 172 in a first DU to CU message. The CU 172 can then determine 506 that the UE 102 is a first UE type (e.g., a reduced capability UE) based on the RRC request (e.g., using any of the techniques discussed above). After the determination 506, the CU 172 can transmit 511 to the DU 174 a first CU to DU message including an RRC response message and an indication that the UE 102 is the first UE type. The DU 174 can forward 508 the RRC response message to the UE 102. After receiving 512 an RRC complete message from the UE 102, the DU 174 can transmit 513 the RRC complete message to the CU 172 in a second DU to CU message.

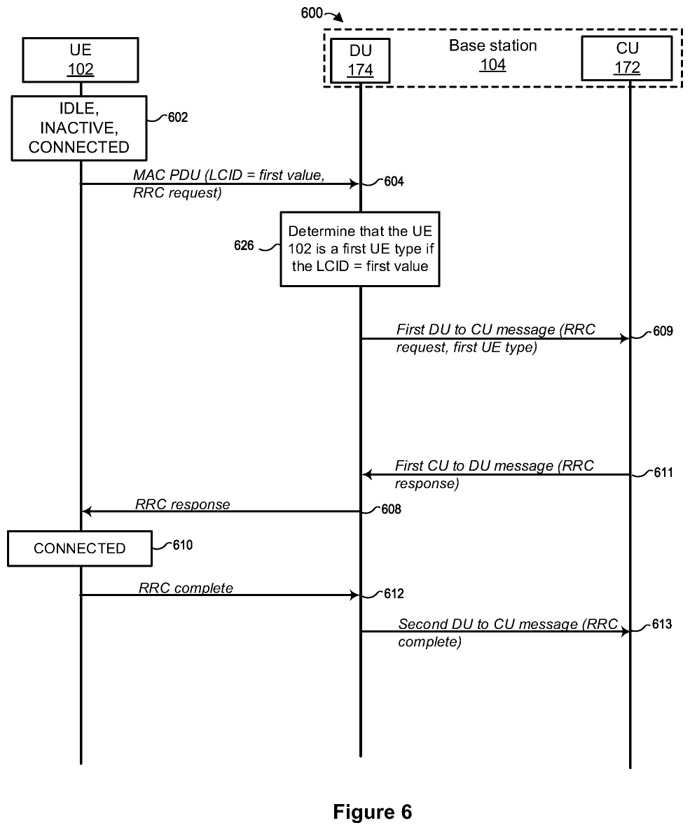

Turning to FIG. 6, a scenario 600 is similar to the scenario 300D. In particular, FIG. 6 illustrates additional messaging between a CU and a DU of a base station that may take place during the scenario 300D. The UE 102 transmits 604 a MAC PDU including an RRC request message and an LCID corresponding to a first value to the base station 104, similar to the event 304D. The DU 174 determines 626 that the UE 102 is a first UE type based on the LCID. In some implementations, the DU 174 transmits 609 a first DU to CU message including the RRC request message and an indication that the UE is the first UE type to the CU 172. In other implementations, the DU 174 transmits a first DU to CU message including the RRC request message to the CU 172, and later transmits the indication that the UE is the first UE type to the CU 172 in a different DU to CU message. In response to the RRC request message, the CU 172 transmits 611 a first CU to DU message including an RRC response message to the DU 174, which in turn forwards the RRC response message to the UE 102. After receiving 612 an RRC complete message from the UE 102, the DU 174 can transmit 613 the RRC complete message to the CU 172 in a second DU to CU message.

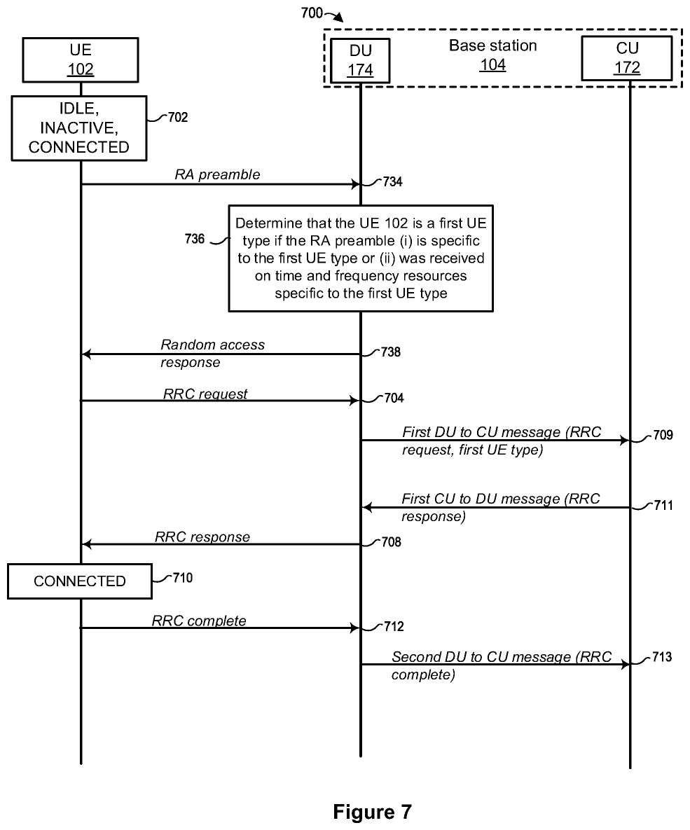

Referring next to FIG. 7, in a scenario 700, a base station determines whether a UE is the first UE type or the second UE type based on a random access preamble that the base station receives during a random access procedure. While the scenario 700 illustrates the random access procedure as a four-step random access procedure, the random access procedure can be a two-step random access procedure in other implementations.

Initially, the UE 102 operates 702 in an idle, inactive, or connected state. The UE 102 initiates a random access procedure with the base station 104 by transmitting 734 a random access preamble to a DU 174 of the base station 104. The DU 174 determines 736 whether the UE 102 is a first UE type or the second UE type based on the random access preamble. In some implementations, the DU 174 determines that the UE 102 is the first UE type if the random access preamble is specific to the first UE type. In other implementations, the UE 102 determines that the UE 102 is the first UE type based on time or frequency resources on which the DU 174 receives the random access preamble, or on time or frequency resources otherwise indicated by the random access preamble. The time or frequency resources may be specific to UEs of the first UE type. Likewise, in other scenarios, the DU 174 may determine that the UE 102 is a second UE type based on the random access preamble.

The DU 174 transmits 738 a random access response message to the UE 102, and the UE 102 transmits 704 an RRC request message to the DU 174. The DU 174 transmits 709 a first CU to DU message to the CU 172 including the RRC request message and an indication of whether the UE 102 is the first UE type or the second UE type.

In some implementations, the CU 172 receives the indication of whether the UE is the first UE type or the second UE type prior to performing a UE capability enquiry procedure with the UE 102. For example, the CU 172 may receive the indication prior to transmitting a UECapabilityEnquiry message, prior to receiving a UECapabilityInformation message UE, or prior to receiving a UE capability IE from the UE or another base station. The CU 172 can adjust a later UE capability enquiry procedure based on whether the UE is the first UE type or the second UE type (e.g., the CU 172 can transmit, via the DU 174, a UECapabilityEnquiry message on time or frequency resources configured for a UE of the first UE type or format the UECapabilityEnquiry message for a UE of the first UE type). For example, in the UECapabilityEnquiry message, the CU 172 can include a request for the UE 102 to indicate the reduced capabilities of the UE 102.

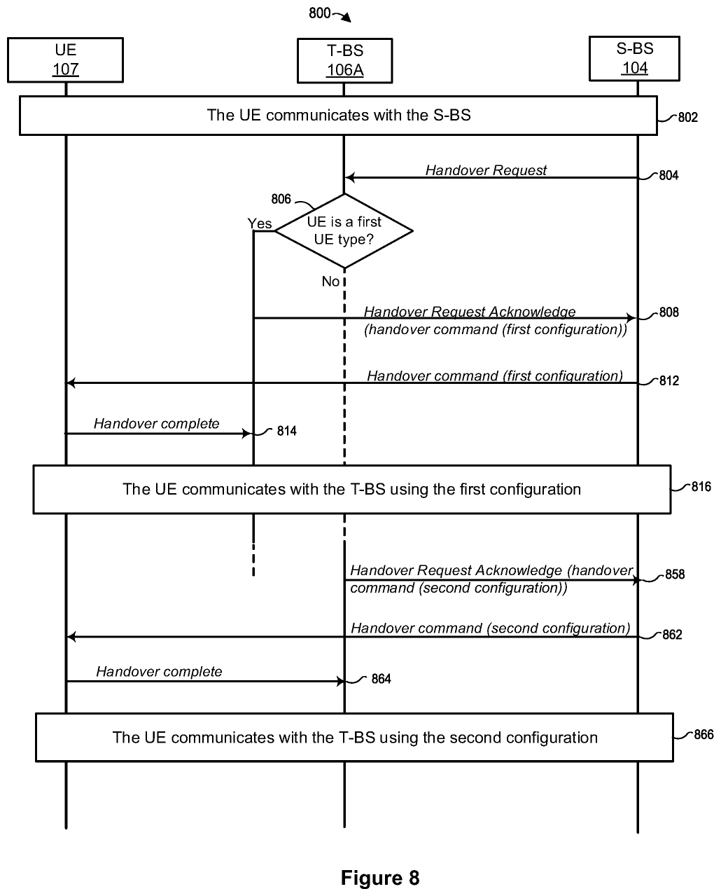

Referring next to FIG. 8, in a scenario 800, a source base station transmits an indication of whether a UE is a first UE type or a second UE type to a target base station during a handover procedure. In the scenario 800, a UE 107 can be the first UE type (e.g., the UE 102), or a second UE type (e.g., the UE 103). The base station 104 operates as a source base station (S-BS), and the base station 106A operates as a target base station (T-BS).

Initially, the UE 107 communicates 802 with the S-BS 104. The S-BS 104 determines whether the UE 107 is the first UE type or the second UE type (e.g., using any of the techniques discussed with reference to FIGS. 3A-7, or based on a UE capability IE). The S-BS 104 transmits 804 a Handover Request message to the T-BS 106A. The Handover Request message includes an indication of whether the UE 107 is the first UE type or the second UE type. In some implementations, the indication can be a flag that explicitly indicates that the UE 107 is the first UE type or the second UE type. In other implementations, the indication can be a UE capability IE or other indication of the capabilities of the UE 107, and the T-BS 106A can determine whether the UE 107 is the first UE type or the second UE type by analyzing the indication.

Based on the Handover Request, the T-BS 106A determines 806 whether the UE 107 is the first UE type or the second UE type. If the UE 107 is the first UE type, the T-BS 106A generates a first configuration for the UE 107 and transmits 808 a Handover Request Acknowledge message including a handover command including the first configuration to the S-BS 104. The T-BS 106A generates the first configuration taking into account that the UE 107 is a reduced capability UE. For example, the first configuration may include parameters suitable for reduced capability UEs or predetermined parameters for reduced capability UEs. The S-BS 104 transmits 812 the handover command including the first configuration to the UE 107, and the UE 107 transmits 814 a handover complete message to the T-BS 106A. The UE 107 can then communicate 816 with the T-BS 106A using the first configuration. In some implementations, the parameters can be related to MIMO operation, transmitting and/or receiving bandwidth, reference signals (e.g., synchronization signal, channel state information reference signal, demodulation signal, and/or sounding reference signal), and/or communication on physical channels such as physical broadcast channel (PBCH), physical random access channel (PRACH), physical downlink control channel (PDCCH), physical uplink control channel (PUCCH), physical downlink shared channel (PDSCH), and/or physical uplink shared channel (PUSCH).

If the UE 107 is not the first UE type (e.g., the UE 107 is a normal capability UE), the T-BS 106A generates a second configuration for the UE 107 and transmits 858 a Handover Request Acknowledge message including a handover command including the second configuration to the S-BS 104. The second configuration may include parameters suitable for a normal capability UE. The S-BS 104 transmits 862 the handover command including the second configuration to the UE 107, and the UE 107 transmits a handover complete message to the T-BS 106A. The UE 107 can then communicate 866 with the T-BS 106A using the second configuration. In some implementations, the parameters can be related to MIMO operation, transmitting and/or receiving bandwidth, reference signals (e.g., synchronization signal, channel state information reference signal, demodulation signal, and/or sounding reference signal), and/or communication on physical channels such as physical broadcast channel (PBCH), physical random access channel (PRACH), physical downlink control channel (PDCCH), physical uplink control channel (PUCCH), physical downlink shared channel (PDSCH), and/or physical uplink shared channel (PUSCH).

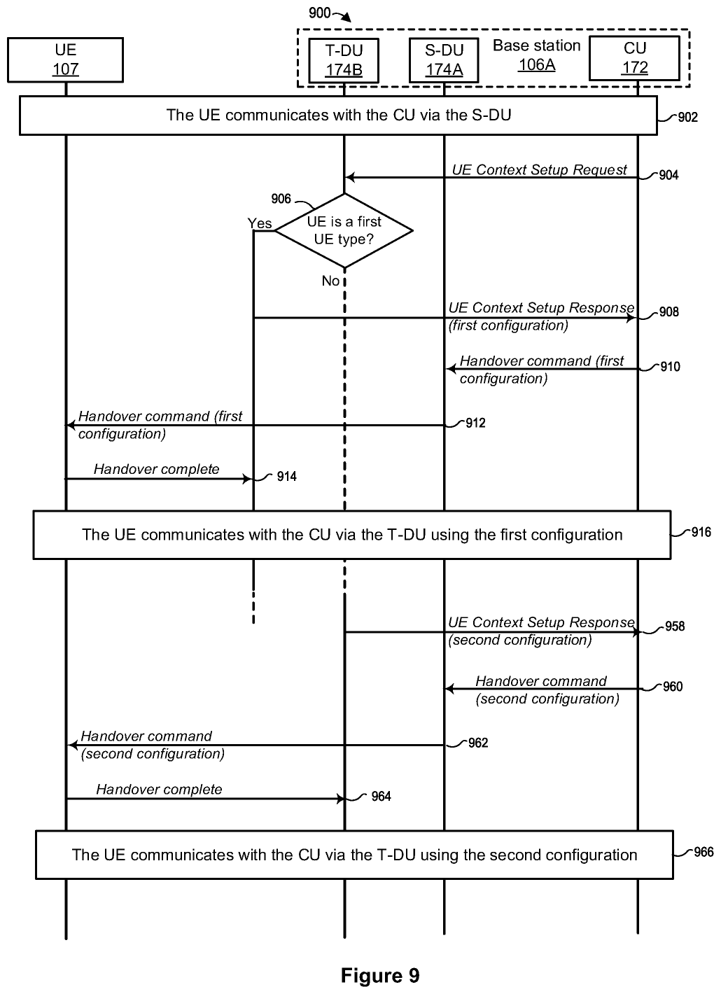

Referring next to FIG. 9, a scenario 900 is similar to the scenario 800 of FIG. 8. However, the handover is an intra-base station handover rather than an inter-base station handover. Similar to the scenario 900, a UE 107 can be the first UE type (e.g., the UE 102), or a second UE type (e.g., the UE 103). The base station 106A includes a CU 172, a source DU (S-DU) 174A, and a target DU (T-DU) 174B.

Initially, the UE 107 communicates with the CU 172 via the S-DU 174A. The CU 172 104 determines whether the UE 107 is the first UE type or the second UE type (e.g., using any of the techniques discussed with reference to FIGS. 3A-7, based on a UE capability IE, and/or based on an indication received from the S-DU 174A). The CU 172 transmits 904 a UE Context Setup Request message to the T-DU 174B. Similar to the Handover Request message 804, the UE Context Setup Request message includes an indication of whether the UE 107 is the first UE type or the second UE type.

Based on the UE Context Setup Request, the T-DU 174B determines 906 whether the UE 107 is the first UE type or the second UE type. If the UE 107 is the first UE type, the T-DU 174B generates a first configuration for the UE 107 and transmits 908 a UE Context Setup Response message including the first configuration to the CU 172. The T-DU 174B generates the first configuration taking into account that the UE 107 is a reduced capability UE. For example, the first configuration may include parameters suitable for reduced capability UEs or predetermined parameters for reduced capability UEs. The CU 172 transmits 910 a handover command including the first configuration to the S-DU 174A, which transmits 912 the handover command to the UE 107. In response, the UE 107 transmits 914 a handover complete message to the T-DU 174B. The UE 107 can then communicate 916 with the CU 172 via the T-DU 174B using the first configuration.

If the UE 107 is not the first UE type (e.g., the UE 107 is a normal capability UE), the T-DU 174B generates a second configuration for the UE 107 and transmits 958 a UE Context Setup Response message including the second configuration to the CU 172. The second configuration is a configuration that is suitable for a normal capability UE. The CU 172 transmits 960 a handover command including the second configuration to the S-DU 174A, which transmits 962 the handover command to the UE 107. In response, the UE 107 transmits a handover complete message to the T-DU 174B. The UE 107 can then communicate 966 with the T-DU 174B using the second configuration.

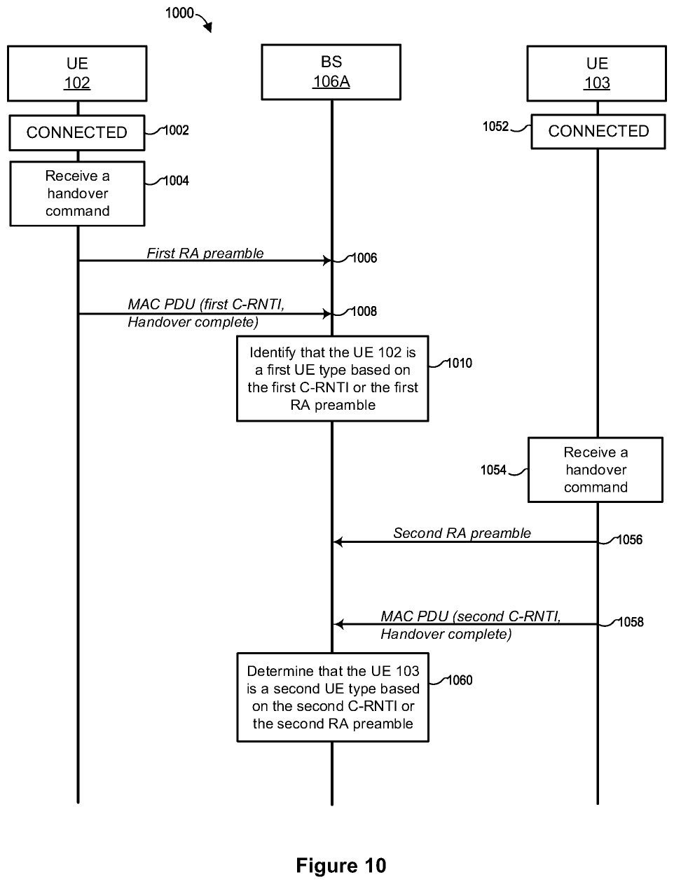

FIG. 10 illustrates a scenario 1000 that may occur after a UE receives a handover command (e.g., after receiving 812 or 862 the handover command).

In some implementations, the UE 102 initially operates 1002 in a connected state with a source base station (e.g., the base station 104). The UE 102 receives 1004 a handover command, similar to the events 812 and 862. In response, the UE 102 performs a random access procedure with a target base station, the base station 106A. To initiate the random access procedure, the UE 102 transmits 1006 a first random access preamble to the base station 106A. At a later time, the UE 102 transmits 1008 a MAC PDU including a handover complete message (e.g., similar to events 814 and 864) and a first Cell RNTI (C-RNTI). In other implementations, the UE 102 initially operates 1002 in a connected state with a source DU of the base station 106A. The UE 102 receives 1004 a handover command, similar to the events 912 and 962. In response, the UE 102 performs a random access procedure with a target DU of the base station 106A. To initiate the random access procedure, the UE 102 transmits 1006 a first random access preamble to the target DU. At a later time, the UE 102 transmits 1008 to the target DU a MAC PDU including a handover complete message (e.g., similar to events 914 and 964) and a first Cell RNTI (C-RNTI). In some implementations, the source DU and the target DU can be the same DU or different DUs.

The base station 106A identifies 1010 that the UE 102 is a first UE type based on the first C-RNTI or the first random access preamble. In some scenarios and implementations, the base station 106A determines that the UE 102 is the first UE type (e.g., using any of the techniques discussed with reference to FIGS. 3A-D, 7 and 9, or based on a UE capability IE) before the handover. In other scenarios and implementations, the base station 106A determines that the UE 102 is the first UE type by using the techniques discussed with reference to FIG. 8 during the handover preparation.

In some implementations, in the handover command 1004, the base station 106A can include a random access configuration configuring the first random access preamble as a dedicated preamble for the UE 102. Thus, the base station 106A can identify that the UE 102 is the first UE type based on the first random access preamble. In other implementations, in the handover command 1004, the base station 106A can include a random access configuration configuring the first random access preamble specifically for UEs of the first UE type. Thus, the base station 106A can identify the UE 102 is the first UE type based on the first random access preamble. In yet other implementations, in the handover command 1004, the base station 106A can include a random access configuration configuring time or frequency resources specific for the UE 102 or UEs of the first UE type. The UE 102 transmits the first random access preamble on the time or frequency resources. Thus, the base station 106A can identify that the UE 102 is the first UE type based on the time or frequency resources on which the base station 106A receives the first random access preamble.

In some implementations, the base station 106A can first attempt to determine the UE type of the UE 102 based on the first random access preamble. If the first random access preamble does not indicate the UE type or the base station 106A is unable to determine the UE type based on the first random access preamble, then the base station 106A can determine the UE type based on the first C-RNTI.

Similar to the I-RNTIs discussed with reference to FIG. 3D, the base station 106A may determine the UE type from the first C-RNTI in a variety of ways. As one example, the base station 106A can determine that the UE 102 is a first UE type because the first C-RNTI maps to a first subset of values associated with reduced capability UEs or otherwise maps to a predetermined range of values associated with reduced capability UEs. As another example, the base station 106A can determine that the UE 102 is a first UE type based on a table or record stored at the base station 106A, which the base station 106A may receive from another base station (e.g., the base station 104), that maps the first C-RNTI to a reduced capability UE.

In some implementations, the UE 103 initially operates 1052 in a connected state with a source base station (e.g., the base station 104). The UE 103 receives 1054 a handover command, similar to the events 812 and 862. In response, the UE 103 performs a random access procedure with a target base station, the base station 106A. To initiate the random access procedure, the UE 103 transmits 1056 a second random access preamble to the base station 106A. At a later time, the UE 103 transmits 1058 a MAC PDU including a handover complete message (e.g., similar to events 814 and 864) and a second C-RNTI. In other implementations, the UE 103 initially operates 1010 in a connected state with a source DU of the base station 106A. The UE 103 receives 1054 a handover command, similar to the events 912 and 962. In response, the UE 103 performs a random access procedure with a target DU of the base station 106A. To initiate the random access procedure, the UE 103 transmits 1056 a first random access preamble to the target DU. At a later time, the UE 103 transmits 1058 to the target DU a MAC PDU including a handover complete message (e.g., similar to events 914 and 964) and a first Cell RNTI (C-RNTI). In some implementations, the source DU and the target DU can be the same DU or different DUs.

The base station 106A identifies 1060 that the UE 103 is a second UE type based on the second C-RNTI or the second random access preamble. In some scenarios and implementations, the base station 106A determines that the UE 103 is the second UE type (e.g., using any of the techniques discussed with reference to FIGS. 3A-D, 7 and 9, or based on a UE capability IE) before the handover. In other scenarios and implementations, the base station 106A determines that the UE 103 is the second UE type by using the techniques discussed with reference to FIG. 8 during the handover preparation.

In some implementations, in the handover command 1054, the base station 106A can include a random access configuration configuring the second random access preamble is a dedicated preamble for the UE 103. Thus, the base station 106A can identify the UE 103 is the second UE type based on the second random access preamble. In other implementations, in the handover command 1004, the base station 106A can include a random access configuration configuring the second random access preamble is specific for UEs of the second UE type. Thus, the base station 106A can identify the UE 103 as the second UE type based on the second random access preamble. In yet other implementations, in the handover command 1054, the base station 106A can include a random access configuration configuring time or frequency resources specific for the UE 103 or UEs of the second UE type. The UE 103 transmits the second random access preamble on the time or frequency resources. Thus, the base station 106A can identify that the UE 103 is the second UE type based on the time or frequency resources on which the base station 106A receives the second random access preamble.

In some implementations, the base station 106A can first attempt to determine the UE type of the UE 103 based on the second random access preamble. If the random access preamble does not indicate the UE type or the base station 106A is unable to determine the UE type based on the random access preamble, then the base station 106A can determine the UE type based on the second C-RNTI. In other implementations, the base station 106A does not attempt to determine the UE type of the UE 103 based on the second random access preamble, because the second random access preamble is a not a dedicated preamble and the time or frequency resources in the handover command 1054 are not specific for UEs of the second UE type or the UE 103.

Similar to the determination 1010, as one example, the base station 106A can determine that the UE 103 is a second UE type because the second C-RNTI maps to a second subset of values associated with normal capability UEs or otherwise maps to a predetermined range of values associated with normal capability UEs. As another example, the base station 106A can determine that the UE 103 is a second UE type based on a table or record stored at the base station 106A, which the base station 106A may receive from another base station (e.g., the base station 104), that maps the second C-RNTI to a normal capability UE.

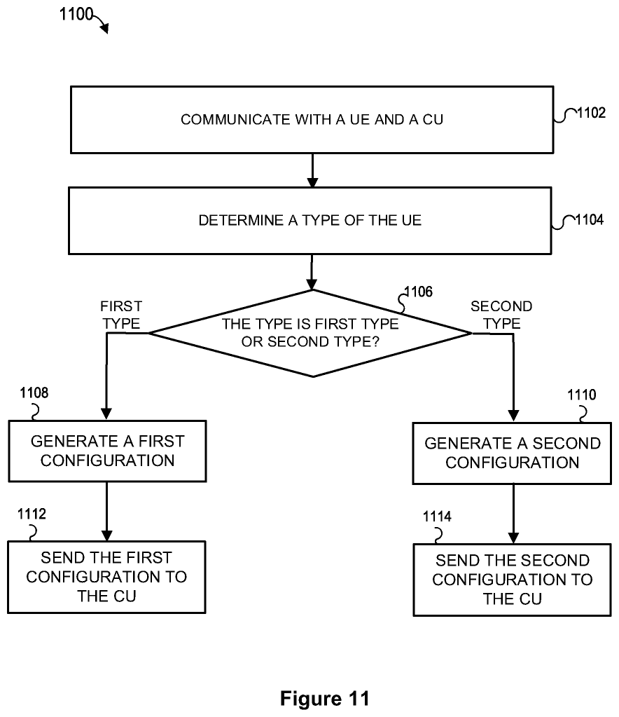

FIGS. 11-15 are flow diagrams of example methods that nodes of a RAN can implement to determine whether a UE is a first UE type (e.g., a reduced capability UE) or a second UE type (e.g., a normal capability UE). FIG. 16 is a flow diagram of an example method that a UE can implement to inform the RAN of whether the UE is a first UE type or a second UE type.

Turning first to FIG. 11, an example method 1100 can be implemented in a DU (e.g., the DU 174, 174A, or 174B) of a base station (e.g., the base station 104, 106A, or 106B). At block 1102, the DU communicates with a UE (e.g., the UE 102, 103, or 107) and a CU (e.g., the CU 172). At block 1104, the DU determines a type of the UE (e.g., whether the UE is a first UE type or a second UE type) (e.g., event 626, 736, 906). Next, the DU determines at block 1106 whether the determined type is a first UE type (e.g., a reduced capability UE) or a second UE type (e.g., a normal capability UE).

If the UE is a first UE type, then the DU at block 1108 generates a first configuration for the UE. The DU can take into account the reduced capabilities of the UE in generating the first configuration. At block 1112, the DU sends the first configuration to the CU (e.g., event 908). If the UE is a second UE type, then the DU at block 1110 generates a second configuration for the UE. The DU can take into account the normal capabilities of the UE in generating the second configuration. At block 1114, the DU sends the second configuration to the CU (e.g., event 958).

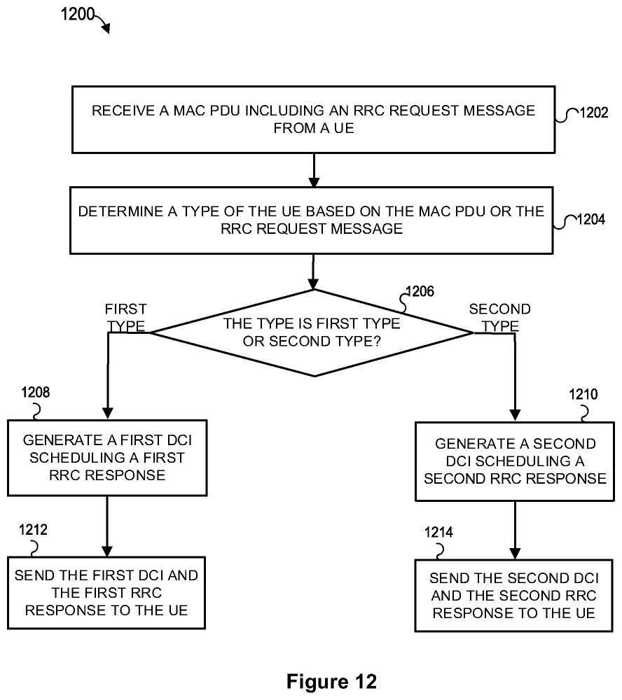

Turning to FIG. 12, an example method 1200 can be implemented in a node of a RAN (e.g., the base station 104, 106A, or 106B, or the DU 174, 174A, or 174B). At block 1202, the node receives a MAC PDU including an RRC request message from a UE (e.g., the UE 102, 103, or 107) (e.g., events 304A-D, 354A-D, 404, 454, 504-509, 604). Based on the MAC PDU or the RRC request message, the node at block 1204 determines a type of the UE (e.g., a first UE type or a second UE type) (e.g., events 306A, 356A, 305B, 355B, 307C, 357C, 326D, 366D, 406, 456, 506, 626). Next, the node determines at block 1206 whether the determined type is a first UE type (e.g., a reduced capability UE) or a second UE type (e.g., a normal capability UE).

If the UE is a first UE type, then the node at block 1208 generates a first DCI scheduling an RRC response (e.g., with configuration parameters the UE is to use to receive the RRC response). The node can take into account the reduced capabilities of the UE in generating the first DCI. At block 1212, the node sends the first DCI and the RRC response to the UE (e.g., events 308A-D, 408, 508, 608). If the UE is a second UE type, then the node at block 1210 generates a second DCI scheduling an RRC response. The node can take into account the normal capabilities of the UE in generating the second DCI. At block 1214, the node sends the second DCI and the second RRC response to the UE (e.g., events 358A-D, 458).

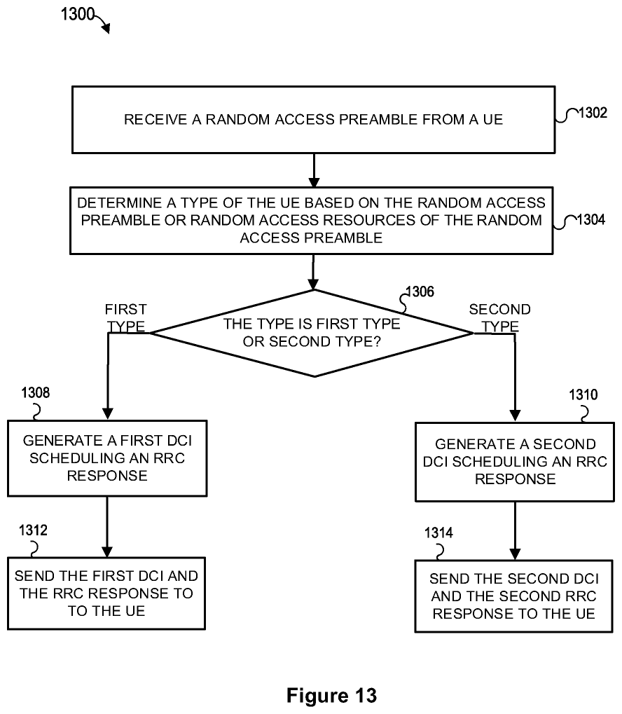

Turning to FIG. 13, an example method 1300 can be implemented in a node of a RAN (e.g., the base station 104, 106A, or 106B, or the DU 174, 174A, or 174B). At block 1302, the node receives a random access preamble from a UE (e.g., the UE 102, 103, or 107) (e.g., event 734 or 1006). At block 1304, the node determines a type of the UE based on the random access preamble or random access resources (e.g., time or frequency resources) of the random access preamble (e.g., event 736 or 1010). Next, the node determines at block 1306 whether the determined type is a first UE type (e.g., a reduced capability UE) or a second UE type (e.g., a normal capability UE).

If the UE is a first UE type, then the node at block 1308 generates a first DCI scheduling an RRC response (e.g., with configuration parameters the UE is to use to receive the RRC response). The node can take into account the reduced capabilities of the UE in generating the first DCI. At block 1312, the node sends the first DCI and the RRC response to the UE (e.g., event 708). If the UE is a second UE type, then the node at block 1310 generates a second DCI scheduling an RRC response. The node can take into account the normal capabilities of the UE in generating the second DCI. At block 1314, the node sends the second DCI and the second RRC response to the UE.

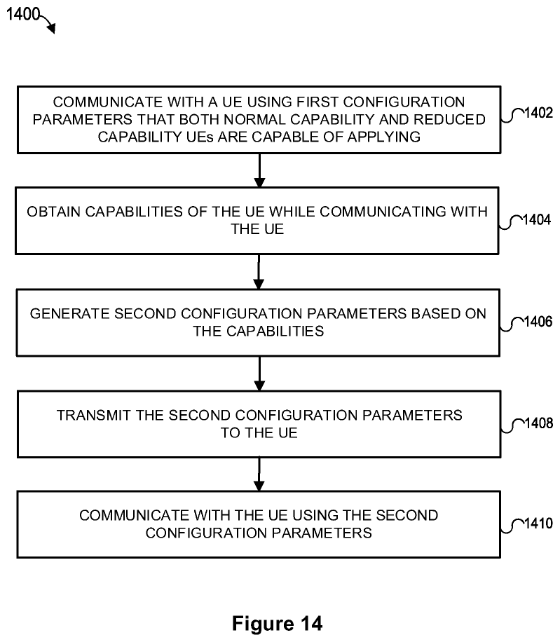

Turning to FIG. 14, an example method 1400 can be implemented in a node of a RAN (e.g., the base station 104, 106A, or 106B, or the DU 174, 174A, or 174B). At block 1402, the node communicates with a UE (e.g., the UE 102, 103, or 107) using first configuration parameters. The first configuration parameters are parameters that both normal capability UEs and reduced capability UEs are capable of applying. At block 1404, the node obtains capabilities of the UE while communicating with the UE. In some implementations, the node may determine that the UE is a reduced capability UE or a normal capability UE (e.g., using any of the techniques discussed above). Additionally or alternatively, the node may receive a UE capability IE (e.g., in a UECapabilityInformation message).

At block 1406, the node generates the second configuration parameters based on the determined capabilities. For example, if the node determines that the UE is a normal capability UE, the second configuration parameters include parameters that reduced capability UEs do not support, but that normal capability UEs are capable of applying. If the node determines that the UE is a reduced capability UE, the second configuration parameters can include parameters more suitable for the reduced capabilities of the UE. At block 1408, the node transmits the second configuration parameters to the UE. At block 1410, the node communicates with the UE using the second configuration parameters.

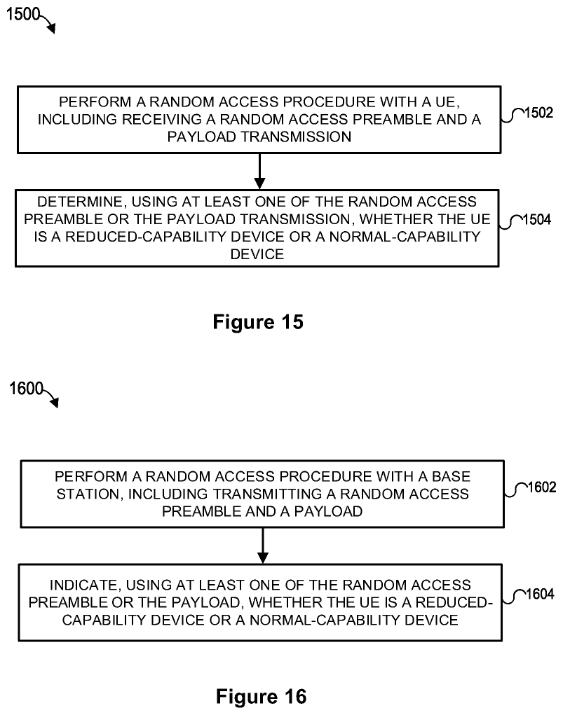

Referring next to FIG. 15, an example method 1500 can be implemented in a base station (e.g., the base station 104, 106A, or 106B) for determining a capability of a UE (e.g., the UE 102, 103, or 107). The base station can perform the method 1500 using processing hardware (e.g., the processing hardware 130 or 140). At block 1502, the base station performs a random access procedure with the UE, including receiving a random access preamble and a payload transmission (e.g., events 304A-D, 354A-D, 404, 454, 504-509, 604, 734, 704, 1006, 1008, 1056, 1058). At block 1504, the base station determines, using at least one of the random access preamble or the payload transmission, whether the UE is a reduced-capability device or a normal-capability device (e.g., events 306A, 356A, 305B, 355B, 307C, 357C, 326D, 366D, 406, 456, 506, 626, 736, 1010, 1060).

Turning to FIG. 16, an example method 1600 can be implemented in a UE (e.g., the UE 102, 103, or 107) for indicating a capability of the UE to a base station (e.g., the base station 104, 106A, or 106B). The UE can perform the method 1600 using processing hardware (e.g., the processing hardware 150). At block 1602, the UE performs a random access procedure with the base station, including transmitting a random access preamble and a payload. At block 1604, the UE uses at least one of the random access preamble or the payload to indicate whether the UE is a reduced-capability device or a normal-capability device (e.g., events 304A-D, 354A-D, 404, 454, 504, 734, 704, 1006, 1008, 1056, 1058).

The following list of examples reflects a variety of the embodiments explicitly contemplated by the present disclosure:

Example 1. A method in a base station for determining a capability of a user equipment (UE), the method comprising: performing, by processing hardware, a random access procedure with the UE, including receiving a random access preamble and a payload transmission; and determining, by the processing hardware and using at least one of the random access preamble or the payload transmission, whether the UE is a reduced-capability device or a normal-capability device.

Example 2. The method of example 1, wherein the determining includes using the payload transmission on a physical uplink shared channel (PUSCH).

Example 3. The method of example 2, wherein: the payload transmission includes a message of a certain type; and the determining is based on the type of the message.

Example 4. The method of example 2, wherein: the payload transmission includes a message including a cause indication; and the determining is based on a type of the cause indication.

Example 5. The method of example 2, wherein: the payload transmission includes a message including a cause indication and at least one other field; and the determining is based on a type of the at least one other field.

Example 6. The method of example 2, wherein: the payload transmission includes a temporary identifier of the UE; and the determining is based on the temporary identifier.

Example 7. The method of example 6, wherein the determining includes: using the temporary identifier to identify a record stored at the base station and related to the UE, the record including a previously determined capability of the UE.

Example 8. The method of example 6, wherein the determining includes: determining that the UE is a reduced-capability device in response to determining that the temporary identifier maps to a first subset of values; and determining that the UE is a normal-capability device in response to determining that the temporary identifier maps to a second subset of values.

Example 9. The method of any one of examples 3-8, wherein the message is associated with a protocol for controlling radio resources between the UE and a radio access network (RAN) of the base station.

Example 10. The method of example 9, wherein receiving the message includes receiving a request to set up, reestablish, or resume a radio connection.

Example 11. The method of any one of examples 3-8, wherein the message is associated with a handover procedure.

Example 12. The method of example 2, wherein: the payload transmission includes a protocol data unit (PDU) of a media access control (MAC) layer, the PDU including a logical channel identity; and the determining is based on the logical channel identity.

Example 13. The method of any one of examples 2-12, including: receiving the payload transmission at a central unit (CU) of the base station via a distributed unit (DU) of the base station; determining, at the CU, whether the UE the UE is a reduced-capability device or a normal-capability device; and transmitting, from the CU to the DU, an indication of whether the UE is a reduced-capability device or a normal-capability device.

Example 14. The method of example 1, wherein the determining includes using the preamble.

Example 15. The method of example 14, wherein the determining includes using at least one of time resources or frequency resources indicated by the preamble.

Example 16. The method of example 1, wherein the determining includes: attempting to determine whether the UE is a reduced-capability device or a normal-capability device using the preamble; and in response to determining that the preamble does not indicate whether the UE is a reduced-capability device or a normal-capability device, using the payload transmission to determine whether the UE is a reduced-capability device or a normal-capability device.

Example 17. The method of any one of examples 1-12 or 14-16, including: determining, at a DU of a base station, whether the UE the UE is a reduced-capability device or a normal-capability device; and transmitting, from the DU to a CU of the base station, an indication of whether the UE is a reduced-capability device or a normal-capability device.

Example 18. The method of any one of the preceding examples, further comprising: generating, by the processing hardware, a downlink control information for the UE based on whether the UE is a reduced-capability device or a normal-capability device.

Example 19. The method of any one of the preceding examples, further comprising: transmitting, by the processing hardware to a target base station, a handover request that includes an indication of whether the UE is a reduced-capability device or a normal-capability device.

Example 20. The method of any one of the preceding examples, wherein performing the random access procedure includes performing a two-step random access procedure.

Example 21. The method of any one of examples 1-19, wherein performing the random access procedure includes performing a four-step random access procedure.

Example 22. A base station including processing hardware and configured to implement a method according to any one of the preceding examples.

Example 23. A method in a user equipment (UE) for indicating a capability to a base station, the method comprising: performing, by processing hardware, a random access procedure with the base station, including transmitting a random access preamble and a payload; and indicating, by the processing hardware and using at least one of the random access preamble or the payload, whether the UE is a reduced-capability device or a normal-capability device.

Example 24. The method of example 23, wherein the indicating includes transmitting the payload on a physical uplink shared channel (PUSCH).

Example 25. The method of example 24, wherein the indicating includes transmitting a message of a certain type in the payload.

Example 26. The method of example 24, wherein the indicating includes transmitting a message including a cause indication in the payload.

Example 27. The method of example 24, wherein the indicating includes transmitting a message in the payload, the message including a cause indication and a certain type of at least one other field.

Example 28. The method of example 24, wherein the indicating includes transmitting a message including a temporary identifier in the payload.

Example 29. The method of any one of examples 25-28, wherein the message is associated with a protocol for controlling radio resources between the UE and a radio access network (RAN) of the base station.

Example 30. The method of example 29, wherein transmitting the payload includes transmitting a request to set up, reestablish, or resume a radio connection.

Example 31. The method of any of examples 25-28, wherein the message is associated with a handover procedure.

Example 32. The method of example 24, wherein the indicating includes transmitting a protocol data unit (PDU) of a media access control (MAC) layer in the payload, the PDU including a logical channel identity.

Example 33. The method of example 23, wherein the indicating includes using the preamble.

Example 34. The method of example 33, wherein the indicating includes indicating at least one of time resources or frequency resources in the preamble.

Example 35. The method of any one of examples 23-34, wherein performing the random access procedure includes performing a two-step random access procedure.

Example 36. The method of any one of examples 23-34, wherein performing the random access procedure includes performing a four-step random access procedure.

Example 37. A user equipment (UE) including processing hardware and configured to implement a method according to any one of examples 23-36.

Example 38: A method in a distributed unit (DU) of a distributed base station, the distributed base station including the DU and a central unit (CU), for determining a capability of a user equipment (UE), the method comprising: receiving, by processing hardware, a random access preamble during a random access procedure with the UE; determining, by the processing hardware and using the random access preamble, whether the UE is a reduced-capability device or a normal-capability device; and transmitting, by the processing hardware to the CU, an indication of whether the UE is a reduced-capability device or a normal-capability device.

Example 39: A method in a base station for determining a capability of a user equipment (UE), the method comprising: receiving, by processing hardware, a payload transmission including a message associated with a protocol for controlling radio resources during a random access procedure with the UE; and determining, by the processing hardware, whether the UE is a reduced-capability device or a normal-capability device based on at least one of: a type of the message, a cause indication included in the message, or a temporary identifier of the UE included in the message.

The following additional considerations apply to the foregoing discussion.

In some implementations, “message” is used and can be replaced by “information element (IE)”. In some implementations, “IE” is used and can be replaced by “field”. The description for the CU or DU can apply to an aggregated base station implementing communication functions of CU and DU for communicating with a UE. In case of the aggregated base station, the messages exchanged between the CU and DU can be omitted or seen as internal computer instructions or internal messages exchanged between different processes in the aggregated base station.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for identifying devices of different capabilities through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a distributed unit (DU) of a base station, the base station including the DU and a central unit (CU), for determining a capability of a user equipment (UE), the method comprising:
receiving, by the DU, a payload transmission during a random access procedure with the UE;
determining, by the DU, using a logical channel identity included in the payload transmission, whether the UE is a reduced-capability device or a normal-capability device; and
transmitting, from the DU to the CU, an indication of whether the UE is the reduced-capability device or the normal-capability device.

2. The method of claim 1, wherein:
the payload transmission includes a protocol data unit (PDU) of a media access control (MAC) layer, the PDU including the logical channel identity.

3. The method of claim 1, further comprising:
generating, by the DU, a downlink control information for the UE based on whether the UE is a reduced-capability device or a normal-capability device.

4. The method of claim 1, wherein the receiving includes receiving the payload transmission on a physical uplink shared channel (PUSCH).

5. A method in a central unit (CU) of a base station, the base station including the CU and a distributed unit (DU), for determining a capability of a user equipment (UE), the method comprising:
receiving, by the CU via the DU, a payload transmission during a random access procedure with the UE;
determining, at the CU, using a logical channel identity included in the payload transmission, whether the UE is a reduced capability device or a normal-capability device; and
transmitting, from the CU to the DU, an indication of whether the UE is the reduced-capability device or the normal-capability device.

6. The method of claim 5, wherein:
the payload transmission includes a protocol data unit (PDU) of a media access control (MAC) layer, the PDU including the logical channel identity.

7. The method of claim 5, wherein transmitting the indication includes:
transmitting, to the DU, a CU-to-DU message including the indication and a message for the UE.

8. The method of claim 5, further comprising:
transmitting, by the CU, to a target base station, a handover request that includes a second indication of whether the UE is the reduced-capability device or the normal-capability device.

9. The method of claim 5, further comprising:
transmitting, by the CU, to a target DU of the base station, an intra-base station handover request that includes a second indication of whether the UE is the reduced-capability device or the normal-capability device.

10. The method of claim 9, wherein transmitting the intra-base station handover request includes transmitting a UE Context Setup Request message.

11. A distributed unit (DU) of a base station, including the DU and a central unit (CU), DU including processing hardware and configured to:
receive a payload transmission during a random access procedure with the UE;
determine, using a logical channel identity included in the payload transmission, whether the UE is a reduced-capability device or a normal-capability device; and
transmit, to the CU, an indication of whether the UE is the reduced-capability device or the normal-capability device.

12. The DU of claim 11, wherein:
the payload transmission includes a PDU of a MAC layer, the PDU including the logical channel identity.

13. The DU of claim 11, further configured to:
generate a downlink control information for the UE based on whether the UE is a reduced-capability device or a normal-capability device.

14. The DU of claim 11, wherein:
to receive the payload transmission, the DU is configured to receive the payload transmission on a PUSCH.

15. A CU of a base station including the CU and a DU, the CU comprising processing hardware and configured to:
receive, via the DU, a payload transmission during a random access procedure with the UE;
determine, using a logical channel identity included in the payload transmission, whether the UE is a reduced capability device or a normal-capability device; and
transmit, to the DU, an indication of whether the UE is the reduced-capability device or the normal-capability device.

16. The CU of claim 15, wherein:
the payload transmission includes a PDU of a MAC layer, the PDU including the logical channel identity.

17. The CU of claim 15, wherein to transmitting the indication, the CU is configured to:
transmit, to the DU, a CU-to-DU message including the indication and a message for the UE.

18. The CU of claim 15, further configured to:
transmit, to a target base station, a handover request that includes a second indication of whether the UE is the reduced-capability device or the normal-capability device.

19. The CU of claim 15, further configured to:
transmit, to a target DU of the base station, an intra-base station handover request that includes a second indication of whether the UE is the reduced-capability device or the normal-capability device.

20. The CU of claim 19, wherein to transmit the intra-base station handover request, the CU is configured to:
transmit a UE Context Setup Request message.
